(19) United States
(12) Patent Application Publication
(10) Pub. No.: US 2002/0007338 A1
(43) Pub. Date: Jan. 17, 2002

(54) Method and apparatus for conducting a bidding session

(76) Inventor: Cuong V. Do, Jung-gu (KR)

Correspondence Address: COVINGTON & BURLING, ATTN: PATENT DOCKETING, 1201 PENNSYLVANIA AVENUE, N.W., WASHINGTON, DC, 20004-2401, US

(21) Appl. No.: 09/847,545

(22) Filed: May 3, 2001

Related U.S. Application Data
(60) Provisional application No. 60/201,742, filed on May 4, 2000.

(51) Int. Cl. G06F 17/60

(52) U.S. Cl. 705/37

(57) ABSTRACT

A method and apparatus for conducting bidding sessions in various modes to arrive at the highest or lowest price. The invention allows a primary user to set the objective of the bidding session (i.e., to obtain the maximum price if the primary user has a good or service to sell, and to obtain the minimum price if the primary user is looking for goods or services to buy). The invention allows bidders to participate in and receive immediate feedback on the status of the bidding session with an ordinary web browser, even if the bidder is working from the opposite side of a firewall. The invention also provides a method and apparatus for hosting bidding sessions conducted on behalf of the primary user.

### RELATED APPLICATIONS

This application claims priority under 35 U.S.C. 119 to provisional application No. 60/201,742, filed May 4, 2000, the entirety of which is incorporated herein by reference.

### BACKGROUND OF THE INVENTION

1. Field of Art

The present invention relates generally to interconnected computer networks, such as the Internet, and more particularly to network communications and data processing systems that facilitate buying, selling or trading goods and services over such a computer network. Still more particularly, the present invention relates to a method and apparatus for conducting online bidding sessions.

2. Related Art

Buying and selling goods and services are an integral part of running any enterprise, and the advent of new communication and computer technologies have enabled new approaches to negotiating and settling on prices in many commercial transactions. One such approach, particularly in the context of business-to-business commercial transactions, is to use an interconnected network of computers, such as the Internet, to bring together multiple buyers or sellers in a virtual bidding room to participate in an online bidding session. These virtual bidding rooms are sometimes referred to as online auctions, e-commerce sites or private exchanges.

In a typical online bidding session, a seller tries to obtain the highest possible sale price for a good or service by permitting multiple interested buyers to submit competing bids to purchase that good or service from the seller (thereby driving the sale price up). Conversely, a buyer tries to obtain the lowest possible sale price for a good or service by permitting multiple interested sellers to submit competing bids to sell the good or service to the buyer (thereby driving the sale price down).

There are procedural and technological problems that undermine the buyers' or sellers' ability to use an online bidding session to get the best possible sale price. From a procedural standpoint, the best sale price typically cannot be achieved when bidders withhold their bids until the online bidding session is about to close (thereby decreasing the risk that another bidder will have an opportunity to submit a better bid). The best price also cannot be achieved when bidders collude to create an artificial ceiling or floor beyond which bids will not go, or to decide in advance who will submit the best bid. The best sale price also cannot be achieved when the price offered for an individual good or service is not apparent from the price offered to buy or sell a bundle of goods or services. In addition, certain technological problems may inhibit or altogether preclude using an online bidding session to achieve the best sale price.

The Internet is a worldwide collection of networks and gateways that use the TCP/IP suite of protocols to communicate with one another. The phrase, “World Wide Web” (“WWW”) refers to the total set of interlinked hypertext documents residing on hypertext transfer protocol (HTTP) servers all around the world. Documents on the WWW, called pages or web pages, are written in hypertext markup language (HTML) and identified by uniform resource locators (URL) that specify the particular machine and pathname by which the web page can be accessed and or downloaded. A website is a related group of these web pages and associated files, scripts, sub procedures, and databases that are served up by an HTTP server, also called a web server, on the WWW. Users need a browser program and an Internet connection to access a website. Browser programs, also called web browsers, are client applications that enable a user to connect to an HTTP server application to transfer files back and forth, execute scripts and sub procedures, access databases, etc. Internet Explorer®, available from Microsoft Corporation of Redmond, Wash., and Netscape®, available from Netscape of Mountain View, Calif., are two popular examples of web browsers in use today.

“Real time” is a term used to describe a level of computer responsiveness that a user senses as substantially immediate or that enables the computer to keep up with some external real-world process as it happens (for example, to present visualizations of constantly changing weather patterns). The term “real-time” is used to describe computers or computer processes that operate in real time. A disadvantage of typical online bidding session systems, such as e-bay (www.ebay.com), is that bidders do not see new bids in real time. In order to receive current bidding status information on these systems, the user must strike a key or click a button that causes the web browser on the user's terminal to send a request to the server that causes the server to send updated status information back to the user's web browser. In an attempt to keep “up-to-date” on the bidding, the user must constantly “refresh” the screen. Given the nature of Internet communications and slow connection speeds, however, the refreshed data could already be obsolete by the time it reaches the user's computer.

Some Internet auction providers, such as FreeMarkets, Inc., have tried to address this problem by requiring specialized, proprietary software-rather than a simple web browser-to be running on the remote terminal. But implementing a bidding session by means of a specialized, proprietary client program running on the remote terminal instead of a simple browser creates other problems and disadvantages. It is much more difficult, for example, to ensure that these specialized and proprietary programs are compatible with the large and diverse number of bidding terminal hardware and software configurations. Moreover, unlike systems that use simple web browser programs, systems that rely on specialized software usually require special user training, as well as special mechanisms for distributing, licensing, upgrading and fixing the software.

A “client” application is a computer program that sends requests to another computer program, called a “server application.” The server application fulfills the requests sent by the client application.

A corporate firewall is a network security measure designed to limit the interaction between users and client applications running “inside the firewall” on an internal corporate local area network, and external server applications running “outside the firewall.” A firewall works by opening or closing its various “ports,” each of which is dedicated to a different communications protocol, and/or regulating the way each port works. Through these actions, the firewall regulates if and how an external server application connects to a client application behind the firewall. Two of the reasons corporations use firewalls are: (1) to prevent the external applications from depositing malicious information inside the corporate network; and (2) to prevent outside parties from extracting confidential files and information from inside the corporate network.

In network environments where a firewall is not used, a user's web browser connects and communicates with a server using any of the various communications protocols (e.g., Hypertext Transfer Protocol (“HTTP”), Transmission Control Protocol (“TCP”), Internet Inter-Orb Protocol (“IIOP”), File Transfer Protocol (“FTP”), Telnet, etc.) and any Internet “ports” available to these protocols. In a network environment where a firewall is in place, the firewall may, for the purpose of enhanced security, restrict communication with the outside world to a certain port, and a single protocol. In most cases, web browsers operating inside a corporate firewall are configured to use only port 80 and only the HTTP protocol to retrieve and display web pages.

“Sockets” is a programming mechanism used to achieve communication between a client application and a server application in a network, which allows data to be exchanged between the applications in real time. A socket connection, however, requires the use of the TCP protocol. Thus, in situations where a firewall prevents or restricts the use of the TCP protocol, a socket connection cannot be used, which means real-time transmissions are not possible. Thus, an alternative mechanism for establishing a real-time connection between the web browser and the server is required.

Accordingly, there is a need in the industry for an online bidding session system capable of automatically extending the time remaining in a bidding session, conducting multiple rounds of bidding, as well as “blind” bidding sessions, and handling multiple-product bidding with price transparency. There is a further need in the art for an online bidding session system capable of accommodating a bidder using a simple web browser from inside a corporate firewall. There is also a need in the art for a simplified approach to installing, using and managing online bidding sessions for multiple clients (buyers and sellers of goods and services).

### SUMMARY OF THE INVENTION

The present invention is directed to a method and apparatus for conducting a bidding session over an interconnected network of computers, while permitting authorized bidders to access the bidding session using a simple web browser program. In one aspect of the invention, a method for conducting a bidding session is provided that comprises the steps of establishing a communications channel between a bidding session server and a web browser residing on a remote terminal, transmitting bidding session status information from the bidding session server to the web browser via the communications channel, receiving a bid from the web browser via the communications channel, and, in response to receiving the bid, transmitting an update of the bidding session status information to at least one web browser residing on at least one remote terminal, wherein the update has not been requested by the web browser.

In a preferred embodiment, the method according to the present invention may also include the functions of: (1) automatically extending the duration of the bidding session by a predetermined period of time in response to receiving a bid; (2) qualifying bidders for the bidding session or for an additional round of bidding; and (3) transmitting updated bidding session status information to the remote terminal through a firewall. In the preferred embodiment, two modes of operation are available. In the first mode, each bidding session update transmitted to the remote terminal contains the value of the bid, along with other information such as the identity of the bidder, the time the bid was received, the rank of the bid, the time remaining in the bidding session, etc. In the second mode, the update is transmitted to the remote terminal without transmitting the bid value (i.e., blind bidding).

In a further aspect of the present invention, a method for conducting bidding sessions for a plurality of clients is provided. The method includes: (1) providing a memory area, coupled to a centralized bidding session server infrastructure, for storing bidding session-related data for each of the plurality of clients; (2) providing security means for preventing unauthorized access to the bidding session-related data; and (3) providing authorized access to the bidding session-related data for one of the clients by a bidding session administrator, where the administrator sets up a bidding session on the centralized bidding session server infrastructure on behalf of that client.

In yet another aspect of the present invention, an apparatus for conducting a bidding session is provided, the apparatus comprising a connection builder configured to establish a communications channel with a web browser residing on a remote terminal, a first transmitter configured to send bidding session status information to the web browser via the communications channel, a receiver that receives a bid from the web browser via the communications channel, and a second transmitter, responsive to the receiver, configured to send an update of the bidding session status information to at least one web browser residing on at least one remote terminal, wherein the update has not been requested by the web browser receiving the update. The preferred embodiment of this apparatus, according to the present invention, may optionally include a qualifier component for qualifying bidders to participate in the bidding session or additional rounds of bidding, a notification component for inviting qualified bidders to participate, a messaging system configured to transmit messages between a bidding session supervisor component and at least one web browser residing on the remote terminal, or all of the above. For this embodiment of the present invention, one of ordinary skill in the art would recognize and appreciate that one, two or any number of separate transmitters and/or receivers could be used to provide any and/or all of the data transmission operations without departing from the scope of the invention.

### Features and Advantages of the Present Invention

It is a feature of the present invention that it can be configured to have no fixed ending time for a bidding session. Bidding sessions can be automatically extended to ensure that the bidding continues as long as bidders are interested, thereby ensuring that the bidding session will only end when all except one bidder have stopped bidding. One advantage to this approach is a bidder who may provide a better sale price does not lose the opportunity to bid merely because a prior bidder waited until the last moment of a fixed-length bidding session to submit his bid.

It is another feature of the present invention that it accommodates bidding from remote terminals running ordinary web browsers, such as Netscape® or Internet Explorer®, and can transmit data to these web browsers even though the browser has not issued a request to refresh the screen. It is yet another feature of the present invention that it operates with these ordinary browsers even when they are located on the opposite side of a corporate firewall. Since no specialized or proprietary bidding software is required for the remote terminals operated by bidders, the present invention costs less to install, maintain and upgrade than other systems, and provides a user interface familiar to most personal computer users.

It is still a further feature of the present invention that it can be configured to provide online bidding sessions having multiple bidding rounds. One advantage of having multiple bidding rounds is that, in any given round, participants tend to bid more aggressively in order to qualify for the next round. In some circumstances, beginning the bidding session with an unusually large number of bidders and then qualifying a subset of those bidders to move on to subsequent rounds provides a useful degree of price uncertainty, which tends to make the bidders compete more aggressively at an earlier stage in the bidding process.

Another feature of the present invention is its ability to provide online bidding sessions in a “price-blind” format. In a price-blind bidding session, bidders only see how their bids rank, not the dollar value of the best bid. As in multiple-round bidding sessions, one advantage of this feature is that bidders tend to bid more aggressively because bidding decisions are based more on the bidder's own price limit, rather than the dollar value of the current best bid. This feature effectively eliminates the practice of following the prices set by others when submitting one's own bids. The feature is especially useful in industries where collusive behavior among bidders tends to be an obstacle to achieving the best sale price.

Still another feature of the present invention is its ability to provide bidding sessions for a bundle of diverse products with price transparency for selected items. There are many situations in which a buyer wants to purchase a variety of related but slightly different products or services from a single supplier (e.g., a restaurant wishing to purchase a variety of produce items, or a corporation wishing to purchase a variety of voice and data communication services). But the buyer may find it difficult, if not impossible, to compare the suppliers' prices because one or more of the suppliers charge a low price for one type of product and an extremely high price on a related but different product. Conducting an online bidding session for multiple products simultaneously and providing price transparency for each major product can, in some cases, lead to a lower overall price for the entire bundle because the price transparency forces bidders to bid in a manner that achieves the lowest overall price. Conversely, conducting an online bidding session for multiple products with price transparency can, in most cases, help a seller sell a bundle of related goods or services at the highest overall price because the price transparency forces bidders to bid in a manner that achieves the highest overall price for the entire bundle.

It is a further feature of the present invention that it provides a secure and highly efficient method for managing online bidding sessions for multiple third party clients or customers. In the preferred embodiment, a site administrator may grant access and certain administrative powers to a group of project leaders, who in turn may grant access and certain administrative powers to certain team members and clients working together on an online bidding effort. One advantage of this feature is that the people closest to the clients have the responsibility for administering and monitoring online bidding sessions for that client, thereby relieving the site administrator of some of the administrative burden involved in managing bidding sessions for multiple clients.

A further feature of the present invention is that it allows a user to specify whether the objective of the bidding session is to arrive at the minimum or maximum price. An advantage of this feature is that it provides the best possible sales price for the user, regardless of whether the user is trying to sell or purchase goods or services.

Additional features and advantages of the invention are set forth in part in the description that follows, and in part are apparent from the description, or may be learned by practice of the invention. The features and advantages of the invention may also be realized and attained by means of the instrumentalities and combinations particularly set out in the appended claims.

### BRIEF DESCRIPTION OF THE FIGURES

The accompanying drawings, which are incorporated in and constitute part of the specification, illustrate preferred embodiments of the invention, and, together with the description, serve to explain the principles of the present invention. In the drawings, like reference numbers indicate identical or functionally similar elements. Additionally, the left-most digit(s) of a reference number identifies the drawing in which the reference number first appears.

FIG. 1 depicts a flow diagram illustrating one embodiment of the present invention.

FIG. 2 depicts a flow diagram illustrating one embodiment of the steps for establishing a connection between a bidding session server and a web browser residing on a remote terminal in one embodiment of the present invention.

FIG. 3 depicts a block diagram of one embodiment of an apparatus for conducting an online bidding session according to the present invention.

FIG. 4 depicts an exemplary computer system, suitable for use with the present invention.

FIG. 5 depicts an exemplary embodiment of a database structure, which can be used in the present invention to store bidding session-related data.

FIG. 6 depicts an exemplary embodiment of a user interface screen displayed on a CRT display or other display, which can be used by the site administrator in the present invention to grant access to team members.

FIG. 7 depicts an exemplary embodiment of the a user interface screen displayed on a CRT display or other display, which can be used in the present invention to set up bidding sessions.

FIG. 8 depicts an exemplary embodiment of a user interface screen which can be used in the present invention to provide team members the ability to grant access to other team members and pre-qualified bidders.

FIGS. 9A and 9B depict an exemplary embodiment of a user interface screen which can be used in the present invention to set up a single-product, single-round bidding session.

FIGS. 10A and 10B depict an exemplary embodiment of a user interface screen which can be used with the present invention to set up a single-product, double-round bidding session.

FIGS. 11A and 11B depict an exemplary embodiment of a user interface screen which can be used with the present invention to set up a multiple-product, single-round bidding session.

FIGS. 12A and 12B depict an exemplary embodiment of a user interface screen which can be used with the present invention to set up a multiple-product, double-round bidding session.

FIG. 13 depicts an exemplary user interface screen which can be used with the present invention to log into a bidding session.

FIGS. 14A, 14B and 14C depict exemplary embodiments of user interface screens which can be used with the present invention to provide access to a virtual bidding room.

FIGS. 15A and 15B depict exemplary embodiments of two user interface screens, which can be used with the present invention to monitor bidding sessions.

### DETAILED DESCRIPTION OF THE PREFERRED EMBODIMENTS

Reference will now be made in detail to the preferred embodiments of the invention, examples of which are illustrated in the accompanying drawings. Notably, the present invention may be implemented using software, hardware or any combination thereof, as would be apparent to those of ordinary skill in the art, and the figures and examples below are not meant to limit the scope of the present invention or its embodiments or equivalents. For the purpose of explanation, numerous specific details, such as certain graphical user interface menus, and the like, are set forth. It will be apparent, however, to one skilled in the art that the present invention may be practiced without these specific details, and is not limited to the specific details shown and described. In other instances, structures and devices are shown in block diagram form to more clearly set forth the present invention.

### Overview of the Present Invention

The present invention is generally directed to a method and apparatus for achieving the best possible price for the sale or purchase of goods or services in a bidding session. It is designed to help maximize the price when the primary user has something to sell, and minimize the price when the primary user is in the market to buy. Typically, although not necessarily, a bidding session system according to the present invention is conducted “online” over an interconnected computer network, such as the Internet. Other forms of interconnected computer networks, e.g., private networks, “Intranets” and “Extranets” may also be used. In a preferred embodiment, participating bidders working from on remote terminals from remote locations are granted simultaneous access, via an Internet, Intranet or Extranet connection, for example, to a bidding session website residing on a bidding session server. The remote terminal may be a personal computer having network access, but could also be a wireless network communications device, such as an Internet-ready wireless telephone. Once logged into the bidding session website, the bidding takes place in a virtual “bidding room.” As stated above, the websites that host and provide access to these online bidding sessions, and the virtual bidding rooms where these bidding sessions take place, are also known in the art as “online auctions,” “B2B exchanges,” or “e-commerce portals.”

In a preferred embodiment, a bidding session system according to the present invention allows the primary user (typically the sponsor of the bidding session or, alternatively, a bidding session administrator) to specify certain bidding session operative modes, such as whether the duration of the bidding session will be fixed or automatically extended as long as bidders are submitting new bids, whether the bidding session will span multiple rounds of bidding, whether the bidding session will provide “price blind” bidding to avoid collusive behavior among bidders, or whether the bidding session will provide for simultaneous bidding on multiple types of products.

The present invention also allows bidders to receive immediate unsolicited feedback on the new bids and the overall status of the bidding session with an ordinary web browser, even if the bidder's terminal is located within a corporate firewall. Another aspect of the present invention provides a secure, efficient and flexible method and apparatus for conducting bidding sessions on behalf of multiple clients in a centralized bidding session infrastructure.

A description of the setup and operation of one preferred embodiment of the present invention will now be provided. This description of a preferred embodiment includes steps and components for setting up and monitoring bidding sessions on behalf of multiple clients in a centralized bidding session infrastructure. However, a person of skill in the art would understand that, except for the multiple-client administrative aspects described herein, the details concerning the underlying format and operation of the actual bidding session are equally applicable to a single-client, decentralized implementation of the invention. Thus, it will be appreciated that the following description is not intended in any way to limit the scope of the present invention to the multiple-client centralized infrastructure model.

In the preferred embodiment of the present invention, a bidding session administrator (i.e., webmaster or site administrator) gives a set of team leaders access to a web server configured to host a bidding session (or, as the case may be, a set of bidding sessions) by creating a User ID for each team leader. The team leaders use their User IDs to access the bidding session server, whereupon they have the authority to grant access to other team members. The team leaders and the team members may then assign User IDs to external parties wishing to participate as users and bidders in the various online bidding sessions.

According to the preferred embodiment, authorized administrators, team members and team leaders access the bidding session server to set up bidding sessions, which can be either single product bidding sessions or multiple-product bidding sessions. Within each type of bidding session, the team leader specifies the manner in which the online bidding session will be conducted, including, for example, whether the object of the session is to minimize or maximize the price, whether the bidding session has a fixed or variable ending time, the number of bidding rounds to be used, whether the participating bidders will be able to see the prices submitted by other bidders, and many other specific attributes of the product(s) and the bidding session (e.g., date and time). The team leader also assigns User IDs to the bidders. In a preferred embodiment, bidders are qualified for participation according to various factors, such as company size, past participation, product-quality level, geographic location, credit history, etc.

Bidders access the invention using their pre-assigned User IDs. After logging into the bidding session server, each bidder will only be able to see information about the bidding sessions for which he or she is qualified to bid. By clicking on certain buttons, the bidder can obtain more detailed information about each bidding session (e.g., product specifications, date and time of bidding, etc.), which has been entered by the team leader who set up the bidding session. At the appointed date and time, bidders may enter a virtual bidding room on the bidding session server to participate in the bidding, as described in more detail below.

In a preferred embodiment, a bidding session server in accordance with the present invention may include one or more memory areas, or databases, which keep track of important information relevant to one or more bidding sessions. These memory areas or databases, typically accessed under the control of one or more database management systems as is known to those in the art, contain information such as: detailed data about the products being put to bid (e.g., product name, category, required quantity, required quality level, etc.); detailed data about the user or bidder (e.g., name, User ID, password, address, access level, etc.); detailed data about the format and status of a bidding session (e.g., bidding objective, bidding start time, bidding end time, number of rounds, etc.); benchmark statistics (e.g., product name, industry name, target savings, actual savings, etc.); or all of the above. Additional memory areas or databases may be included in the system as required to enable other functionalities of this and other embodiments of the present invention as described herein, or as may be needed in order to practice the present invention in a particular situation or environment.

To address the problems associated with corporate firewalls, the present invention includes a “connection builder” to establish the connection with the remote terminal in situations where the remote terminal is located inside a corporate firewall. When a bidder enters a “bidding room” via a web browser, this act causes the connection builder to copy itself into the memory of the user's terminal, whereupon it is automatically executed. At this point, the connection builder goes through the following steps to establish a connection between the bidding session server and the web browser client.

First, the connection builder determines whether a firewall exists. If no firewall exists, then the connection builder checks to see if a cache or proxy server is running. If not, a sockets connection can be made to the server using Transmission Control Protocol (“TCP”) using a port, such as port 3879, and the connection can be maintained using Internet Protocol (“IP”). However, if a cache or proxy server is running, the connection builder still attempts to establish a sockets connection with the server via TCP, but the connection builder maintains the connection by managing the user's unique connection “handle” instead of IP (the handle specifically identifies each user instead of an IP address).

If a firewall exists, the connection builder determines whether the firewall supports the Internet Inter-ORB Protocol (“IIOP”) and whether an IIOP port is available. As is known in the art, IIOP is an object-oriented programming protocol, defined by the Common Object Request Broker Architecture (“CORBA”) standard, that makes it possible for distributed programs written in different languages to communicate over the Internet. If IIOP is supported, the connection builder establishes a sockets connection to the server using the IIOP protocol and port. If IIOP is not supported, the connection builder looks for other protocols and ports that are available (e.g., FTP, Telnet, POP3). If any of these ports are available, the connection builder establishes a sockets connection with the server using one of these ports.

As a last resort, the connection builder uses an “HTTP tunneling” technique to make the connection, which allows the connection builder to mimic a sockets connection, but accomplishes this connection using the HTTP protocol. Normal HTTP protocol connections do not allow real-time updates to be received by the client browser program. This is why other methods of conducting bidding sessions online using simple web browsers have to constantly refresh their pages. The connection builder of the present invention acts as a special web server that uses HTTP tunneling to first establish a connection and then maintains that connection between the client and server, thereby mimicking a real-time “socket-connection.”

After the connection is made in one of the above-described methods, and a communications channel is open, the bidding session server uses the communications channel to provide real-time updates of the bidding session status information to the web browser.

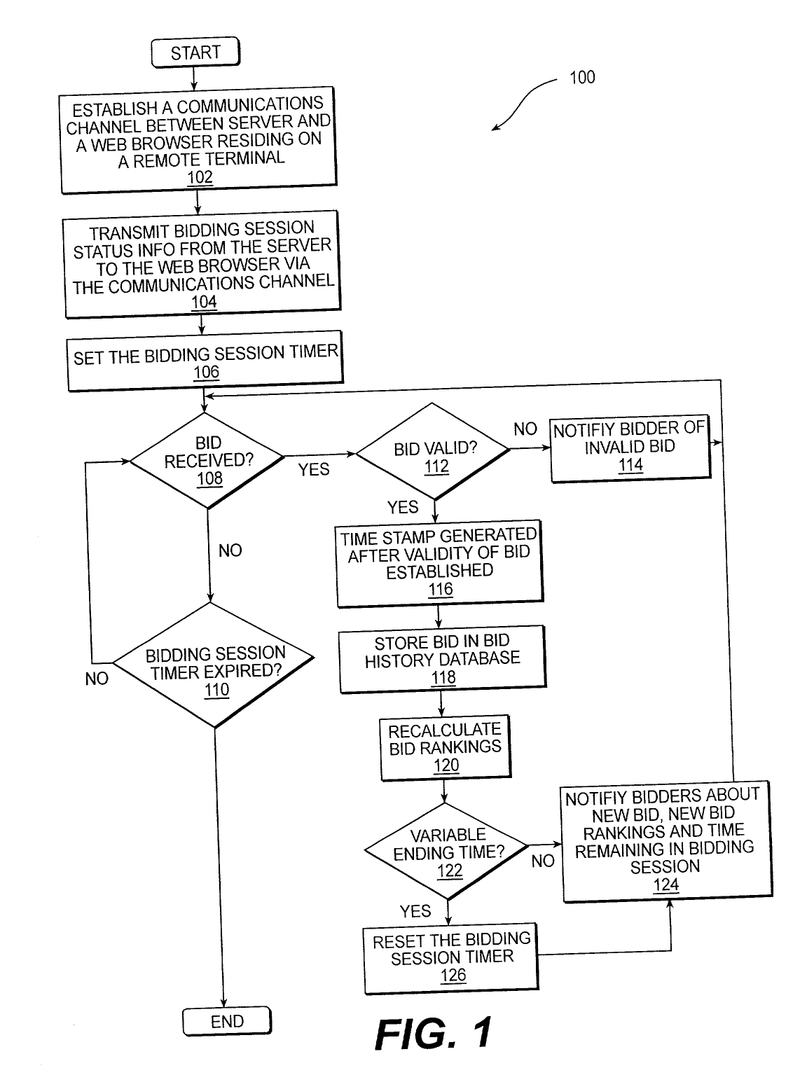

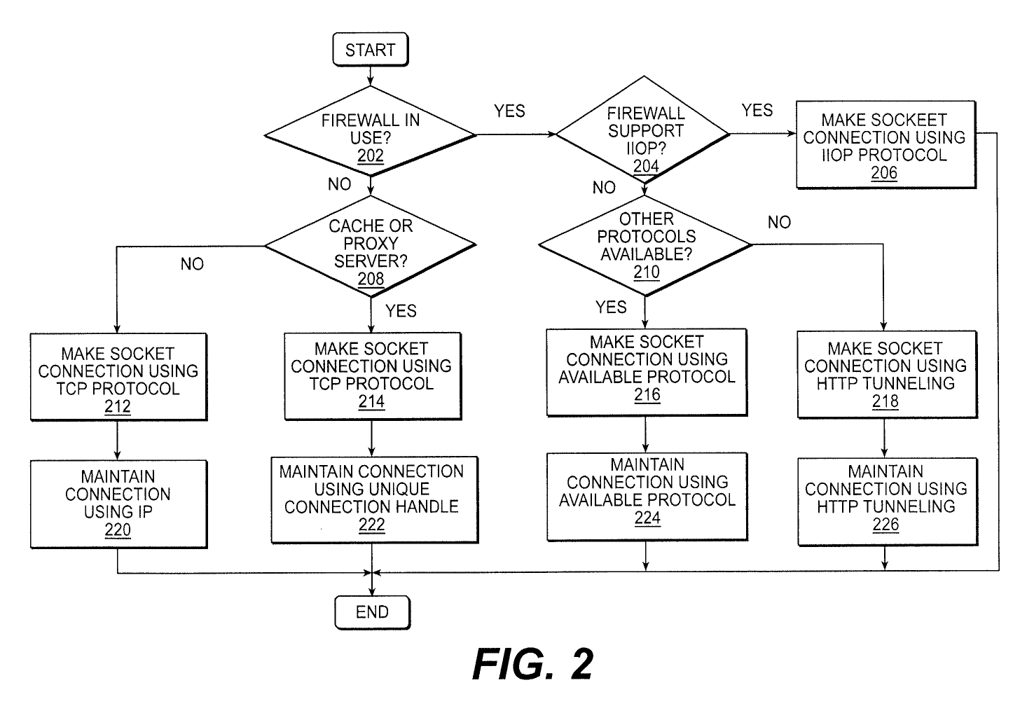

With reference now to the figures, a more detailed description of the preferred embodiment of the present invention is now provided. FIG. 1 illustrates the general workflow of a bidding session in accordance with one embodiment of the present invention. First, when a bidding session begins, a connection is established between the bidding session server and a web browser residing on a remote terminal, step 102. As stated above, the bidding session server and the remote terminal may be coupled to the Internet, an intranet or an extranet. The connection is established, in a preferred embodiment, by executing the steps described more fully below and with reference to FIG. 2. After the connection is established between the bidding session server and the remote browser, the bidding session server transmits status information to the web browser, as in step 104. The transmission of bidding session status information typically, although not necessarily, includes a starting bid value, a last bid value, a bidding rank, identification information about the bidder or bidders who have submitted bids, and a bidding history.

In the preferred embodiment, general information about the bidding session would typically be transmitted to prospective bidders prior to the bidding session start time. For example, prior to the opening of the bidding, prospective bidders could be notified about the bidding session via telephone, facsimile, email or letter. The notification, which would include information such as the name of the entity sponsoring the bidding session, the objective of the bidding session, the format of the session, the date and time the bidding will open, information about the product(s) or service(s) being put to bid, the contract terms being sought by the sponsor, the bidding currency, etc., could also be published on a web page accessible to prospective bidders. More or less information may be provided, depending on and according to the nature and objectives of the bidding session.

After the initial bidding session status information is transmitted, the bidding session timer is reset to some predetermined value, step 106. In the preferred embodiment, the bidding session timer counts down to zero from the predetermined value. However, depending on the circumstances, a bidding session timer that starts at zero and counts up to the predetermined value may be provided. At this point, the system checks to see if a bid has been received, step 108. If no bid is received, the bidding session timer is checked, in step 110, to see if the time for the bidding session is expired. If the bidding session timer has expired (by reaching 0, if counting down, or by reaching the predetermined value, if counting up), the bidding session ends.

At step 112, the value of the bid is evaluated to determine whether or not it is valid. If the bid is invalid, then the system notifies the bidder of the error (step 114) and processing continues at step 108 again, where the system checks to see if another bid is received. If, on the other hand, the bid is valid, a timestamp is generated for the bid (step 116) to indicate the exact order of bid submissions. The bid is stored in a bid history database at step 118. Then, at step 120, the bid rankings are recalculated in light of the new bid.

At this point, the system checks, at step 122, to see whether the bidding session must end at a specific time or if it is to be extended due to the last bid. If the bidding session is set up to have a fixed ending time, the system notifies all bidders of the new bid, the new rankings and the time remaining in the bidding session, step 124. If the format of the bidding session is blind, then the value of the new bid would not be included in the updated bidding status information transmitted to the remote browser. In this case, only the new ranking information is transmitted. If the bidding session has been configured, as in a preferred embodiment, to be automatically extended whenever someone submits a bid (i.e., a variable ending time), the bidding session timer is reset before updated status information is transmitted to the bidders. After the update has been transmitted, control passes once again back to step 108, where the system checks to see whether a bid has been received.

In the preferred embodiment, steps 108, 112, 114, 116 118, 120, 122, 124 and 126 operate to form a continuous processing loop that will be executed repeatedly until the bidding session timer is expired. However, those of skill in the art would recognize that one or more alternative conditions could be added to this processing loop, such as a condition based on the total number of bids received or the value of the bids, which could be used to trigger the termination of the bidding session or the resetting of the bidding session timer.

The operation of the connection builder will now be described in more detail with reference to FIG. 2, which depicts a preferred embodiment for establishing a connection between the bidding session server and a web browser residing on a remote terminal. In such a preferred embodiment, the connection builder process is first copied to the memory of the remote terminal, where it begins execution.

First, in a step 202, the connection builder determines whether a firewall exists. If no firewall exists, then the connection builder checks to see if a cache or proxy server is running, step 208. If not, a sockets connection for the bidding session server is created using the TCP protocol and via a port such as port 3879, step 212. After the sockets TCP connection is established, the communication channel is maintained using IP, step 220. If, however, a cache or proxy server is running on the remote terminal, a sockets connection is created using TCP (step 214), but the communication channel is maintained by managing the user's unique connection “handle” instead of IP (the handle identifies each user instead of an IP address). See step 222.

If, in step 202, it is determined that a firewall is in use, the connection builder determines whether the firewall supports the IIOP protocol and whether there is an IIOP port available, step 204. If IIOP is supported, a sockets connection to the bidding session server is created in step 206 using the IIOP protocol and the associated IIOP port. If IIOP is not supported, the connection builder searches the configuration of the networking system in the remote terminal for other protocols and ports that are available (e.g., FTP, Telnet, POP3). See step 210. If any of these other protocols and ports are available, a sockets connection is established and maintained with the bidding session server via one of these protocols and ports, steps 216 and 224.

If, at step 210, it is determined that no other protocols or ports are available, a connection is made and maintained using HTTP tunneling, depicted as steps 218 and 226 in FIG. 2, as is known by those of skill in the art. After the connection is made in one of the above-described methods, and a communications channel is open, the bidding session server uses the communications channel to provide real-time updates of the bidding session status information to the web browser, as more fully described in steps 104 and 116 above, and as shown in FIG. 1.

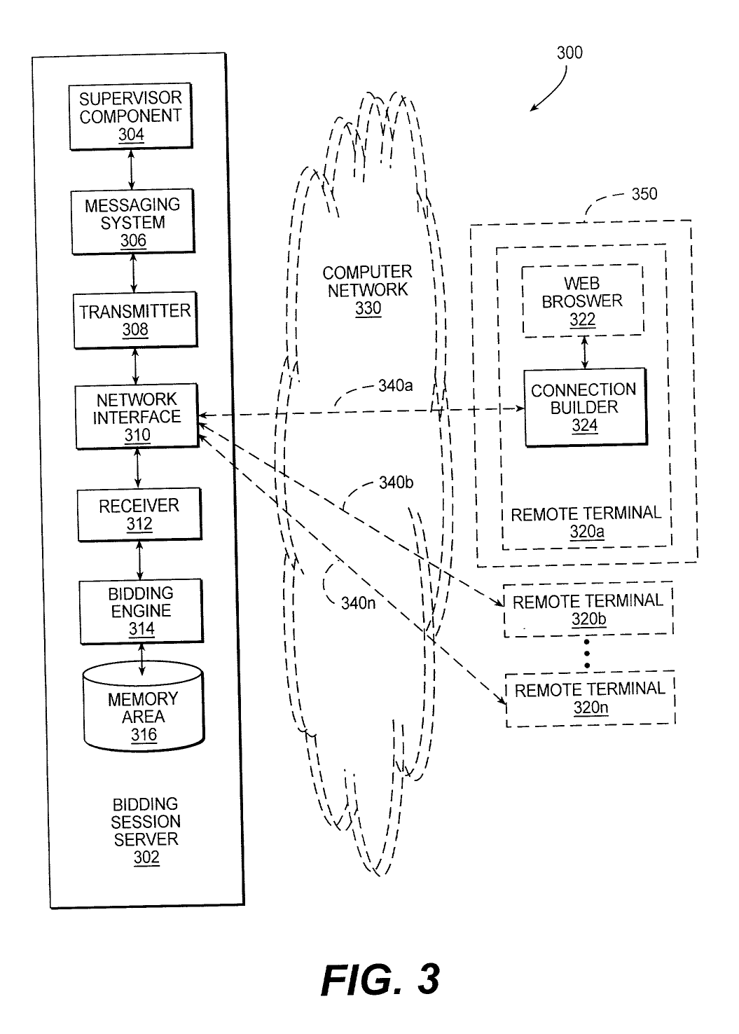

FIG. 3 shows a block diagram of a preferred embodiment of an apparatus 300 for conducting bidding sessions in accordance with the present invention. The apparatus 300 is comprised of a bidding session server 302, a supervisor component 304, a messaging system 306, a transmitter 308, a network interface 310, a receiver 312, a bidding engine 314, a memory area 316 and a connection builder 324.

The bidding session server 302 is coupled via network interface 310 to a computer network, such as the Internet, depicted in FIG. 3 as 330. Also connected to computer network 330, is any number of remote terminals, depicted in FIG. 3 as 320a through 320n, which each have residing on them one or more simple web browser programs, depicted in FIG. 3 as 322. As stated above, remote terminals 320a through 320n may consist of personal computers with network connectivity, but remote terminals consisting of other network-capable devices, such as wireless telephones and wireless handheld Internet devices, could be used.

Typically, although not necessarily, connection builder 324 is copied to remote terminal 320a prior to the beginning of a bidding session. (For simplicity, the firewalls, web browser programs and connection builders associated with remote terminals 320b through 320n are not depicted in FIG. 3). As more fully described above with reference to FIG. 2, the connection builder 324 first establishes a connection with the bidding session server 302 via network interface 310 in order to allow real-time communication of data between bidding session server 302 and the remote terminal 320a via communication channel 340a and through firewall 350. Depending on the format and circumstances of the bidding session, bidding session server 302 may simultaneously establish connections to remote terminals 320b through 320n via communications channels 340b through 340n.

Network interface 310 is coupled to transmitter 308 and receiver 312, so that bids received from web browser 322 via connection builder 324 and communication channel 340a are passed from network interface 310 to receiver 312, and bidding status information to be transmitted to web browser 322 is passed from transmitter 308 through network interface 310 and out communication channel 340a to remote terminal 320a. In the preferred embodiment, messaging system 306 is connected to provide a mechanism for transmitting messages from supervisor component 304 to transmitter 308, which, in turn, passes those messages to connection builder 310 for transmittal across communication channel 340a. Supervisor component 304 typically, although not necessarily, comprises a computer program configured to allow a team leader or site administrator to monitor bidding activity.

For the sake of clarity, the embodiment illustrated in FIG. 3 shows transmitter 308, network interface 310 and receiver 312 as three separate components. One of skill in the art would recognize and appreciate, however, that the functionality of these components could alternatively be accomplished using only one program, process or device. Likewise, one of skill in the art, after reading this disclosure, would recognize that some situations may call for using two or more transmitters, two or more receivers or two or more network interfaces to accomplish the same functions.

Also for the sake of clarity, the illustration in FIG. 3 shows each component of bidding session server 302 connected to the next component in a linear fashion (i.e., supervisor component 304 is connected to messaging system 306, which is in turn connected to transmitter 308, and so on). However, one of ordinary skill in the art would appreciate that these components could be physically connected in any number of alternative arrangements, and that these alternative arrangements would not depart from the scope of the invention. One might decide, for example, to use direct (or parallel) connections between bidding engine 324, supervisor component 304 and transmitter 308, rather than having those components connected in series, as illustrated in FIG. 3.

The apparatus 300 also comprises a bidding engine 314, which monitors and controls the bidding session according to parameters set by a bidding session administrator (not depicted). In the preferred embodiment, these parameters are maintained in memory area 316, along with, for example, current and historical bidding status information, benchmarking information, or other information as may be required by the particular circumstances. Although only one memory area, memory area 316, is shown in FIG. 3, it will be appreciated by one of skill in the art that an apparatus according to the present invention may implement the system by including more than one memory area and/or housing the memory areas at locations that are remote from the other components of the system.

In a preferred embodiment, bidding engine 314 simultaneously manages three parallel and interrelated streams of tasks: 1) participants management; 2) time management; and 3) bid management. With respect to participants management, bidding engine 314 monitors which bidders have entered or exited the bidding room. This real-time monitoring is possible because connection builder 324 creates a socket connection between each bidder's remote terminal (depicted as 320a in FIG. 3) and the bidding session server 302, thereby providing real-time information on who is currently logged into the bidding room (creation of the connection is described in detail above with reference to FIG. 2).

With respect to time management, bidding engine 314 monitors the bidding session timer to determine how much time remains in the bidding session. If the bidding session is set up to extend for as long as participants are bidding (i.e., variable ending time), bidding engine 314 resets the bidding session timer each time a valid bid is entered. When the remaining time runs out, bidding engine 314 closes the bidding session and notifies the bidders that the session has ended, using, for example, predetermined message strings entered by a system administrator.

Finally, with respect to bid management, bidding engine 314 monitors the entry of new bids. When a new bid is entered, bidding engine 314 processes the bid (providing a time stamp, validating the bid, recalculating bid rankings, storing the bid in the database, etc.) as more fully described above with reference to steps 112, 114, 116, 118, 120, 122, 124 and 126 of FIG. 1.

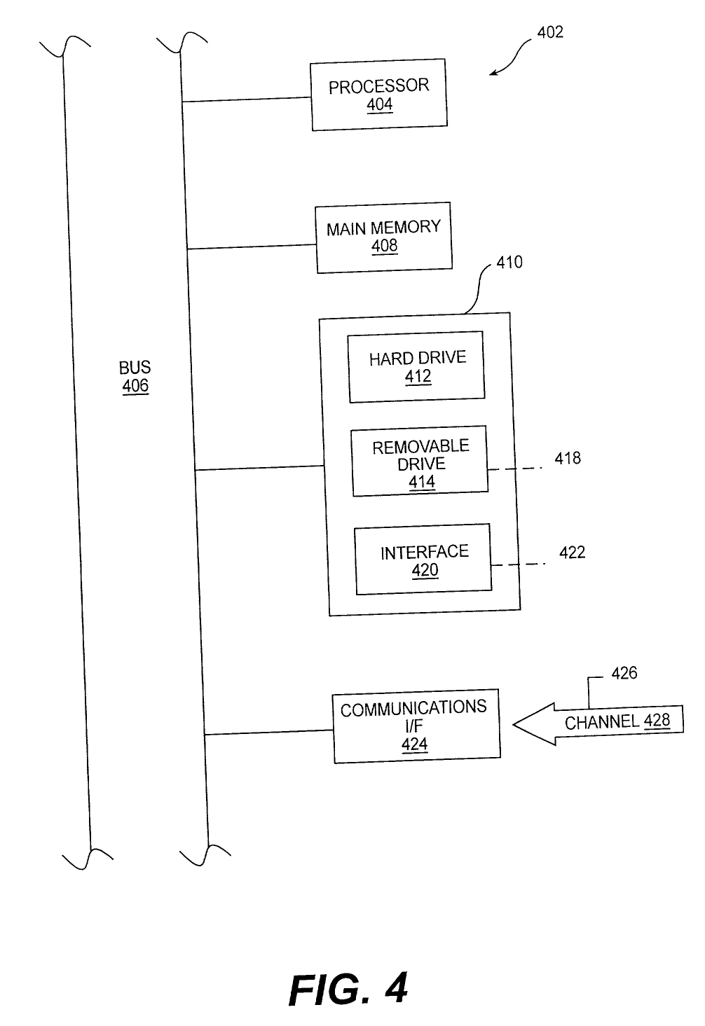

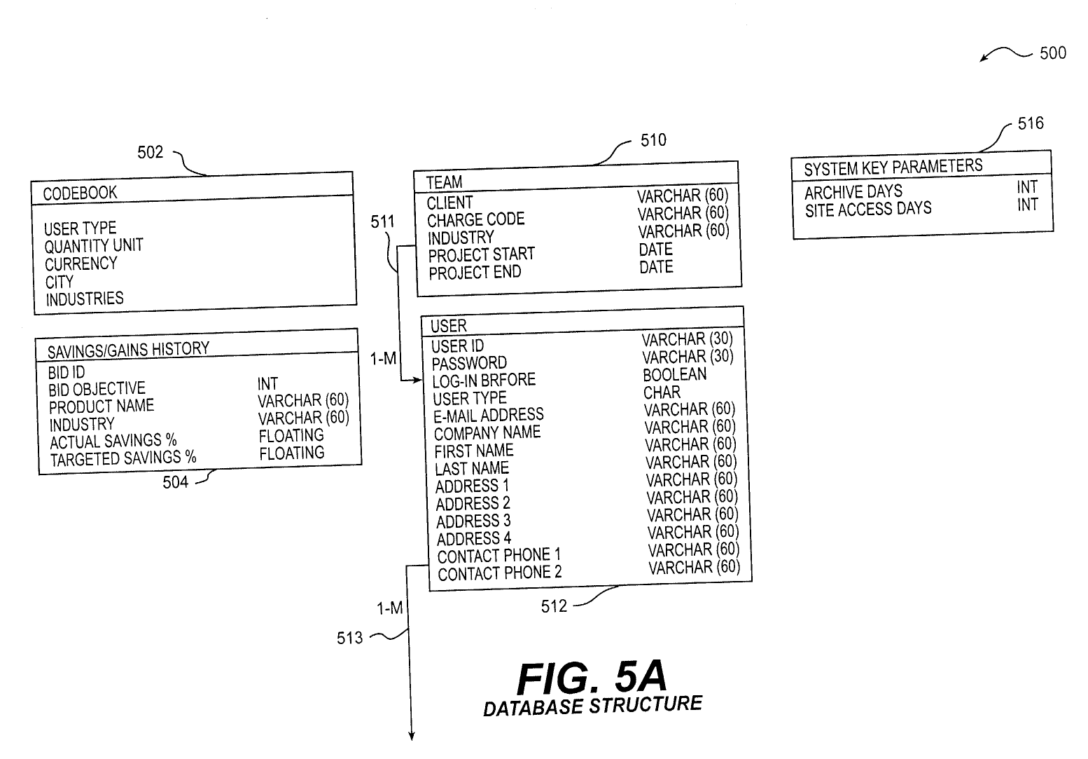

With reference now to FIG. 4, a more complete description of a computer system suitable for use with the preferred embodiment of the present invention is provided. The computer system 402 includes one or more processors, such as a processor 404. The processor 404 is connected to a communication bus 406. Various software embodiments are described in terms of this exemplary computer system. After reading this description, it will become apparent to a person skilled in the relevant art how to implement the invention using other computer systems and/or computer architectures.

The computer system 402 also includes a main memory 408, preferably random access memory (RAM), and can also include a secondary memory 410. The secondary memory 410 can include, for example, a hard disk drive 412 and/or a removable storage drive 414, representing a floppy disk drive, a magnetic tape drive, an optical disk drive, etc. The removable storage drive 414 reads from and/or writes to a removable storage unit 418 in a well-known manner. The removable storage unit 418, represents a floppy disk, magnetic tape, optical disk, etc. which is read by and written to by the removable storage drive 414. As will be appreciated, the removable storage unit 418 includes a computer usable storage medium having stored therein computer software and/or data.

In alternative embodiments, the secondary memory 410 may include other similar means for allowing computer programs or other instructions to be loaded into the computer system 402. Such means can include, for example, a removable storage unit 422 and an interface 420. Examples of such can include a program cartridge and cartridge interface (such as that found in video game devices), a removable memory chip (such as an EPROM, or PROM) and associated socket, and other removable storage units 422 and interfaces 420 which allow software and data to be transferred from the removable storage unit 422 to the computer system 402.

The computer system 402 can also include a communications interface 424. The communications interface 424 allows software and data to be transferred between the computer system 402 and external devices. Examples of the communications interface 424 can include a modem, a network interface (such as an Ethernet card), a communications port, a PCMCIA slot and card, etc. Software and data transferred via the communications interface 424 are in the form of signals 426 that can be electronic, electromagnetic, optical or other signals capable of being received by the communications interface 424. Signals 426 are provided to communications interface via a channel 428. A channel 428 carries signals 426 and can be implemented using wire or cable, fiber optics, a phone line, a cellular phone link, an RF link and other communications channels.

In this document, the terms “computer program medium” and “computer usable medium” are used to generally refer to media such as the removable storage device 418, a hard disk installed in hard disk drive 412, and signals 426. These computer program products are means for providing software to the computer system 402.

Computer programs (also called computer control logic) are stored in the main memory 408 and/or the secondary memory 410. Computer programs can also be received via the communications interface 424. Such computer programs, when executed, enable the computer system 402 to perform the features of the present invention as discussed herein. In particular, the computer programs, when executed, enable the processor 404 to perform the features of the present invention. Accordingly, such computer programs represent controllers of the computer system 402.

In an embodiment where the invention is implemented using software, the software may be stored in a computer program product and loaded into the computer system 402 using the removable storage drive 414, the hard drive 412 or the communications interface 424. The control logic (software), when executed by the processor 404, causes the processor 404 to perform the functions of the invention as described herein.

In another embodiment, the invention is implemented primarily in hardware using, for example, hardware components such as application specific integrated circuits (ASICs). Implementation of such a hardware state machine so as to perform the functions described herein will be apparent to persons skilled in the relevant art(s). In yet another embodiment, the invention is implemented using a combination of both hardware and software.

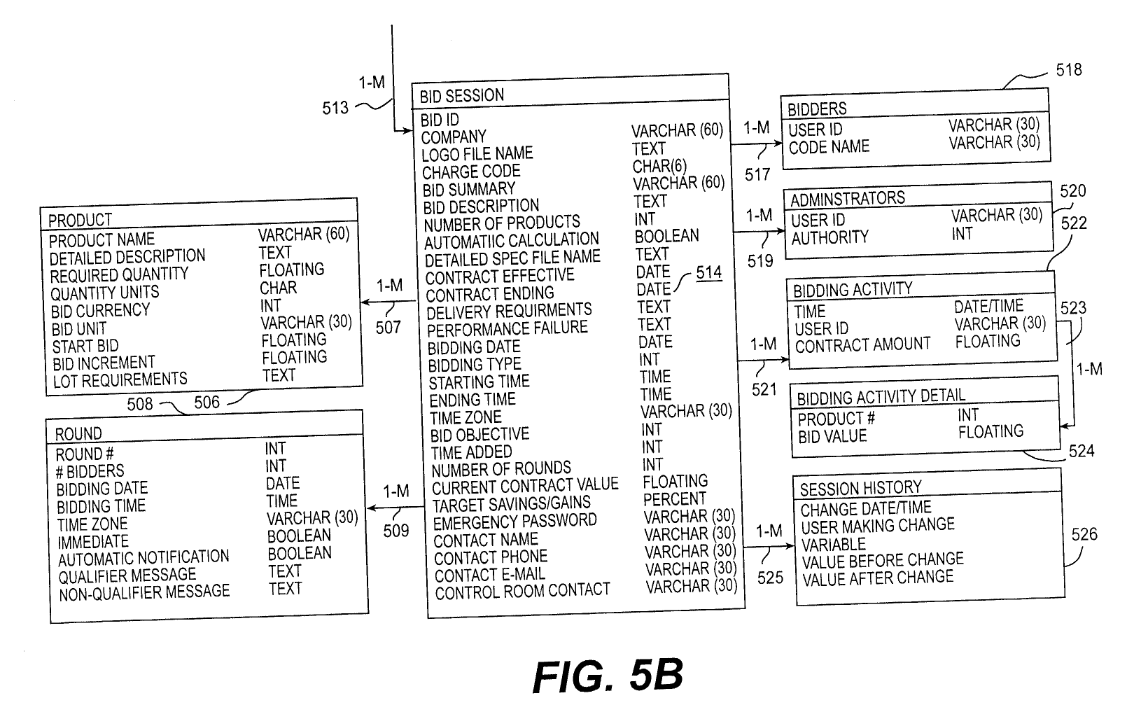

An exemplary database structure suitable for use in a preferred embodiment of the present invention is illustrated in FIG. 5. The database structure comprises database tables designed to accommodate key pieces of bidding session-related data for one embodiment of the invention. For example, a product table 506 is included, which contains information about the products being put to bid, such as product name, product description, quantity and lot requirements. Also included is a user table 512, which contains information about users of the system, such as User ID, password, e-mail address, first and last name and contact information. In a preferred embodiment, a bid session table 514 contains records relevant to an individual bid session, including, for example, a bid description, starting time, ending time, delivery requirements, number of rounds, contract value, etc. The database structure also comprises: a codebook table 502, for keeping track of information about certain codes; a savings/history table 504, for keeping track of actual and targeted savings for certain products and industries; a round information table 508, for keeping track of bidding round information, such as the current round number and the number of bidders in each round; and a team table 510, for storing information about the client, the industry and the certain project start and end dates. The embodiment of the database structure depicted in FIG. 5 also includes separate tables for system key parameters 516, bidders 518, administrators 520, bidding activity 522, bidding activity detail 524 and session history 526. For efficient search and retrieval of the database, in a preferred embodiment, the database structure is configured such that a number of these tables are defined in such a way as to create a one-to-many relationship with other tables within the structure. In the embodiment shown in FIG. 5, these one-to-many links are illustrated with arrows 507, 509, 511, 513, 517, 519, 521, 523 and 525.

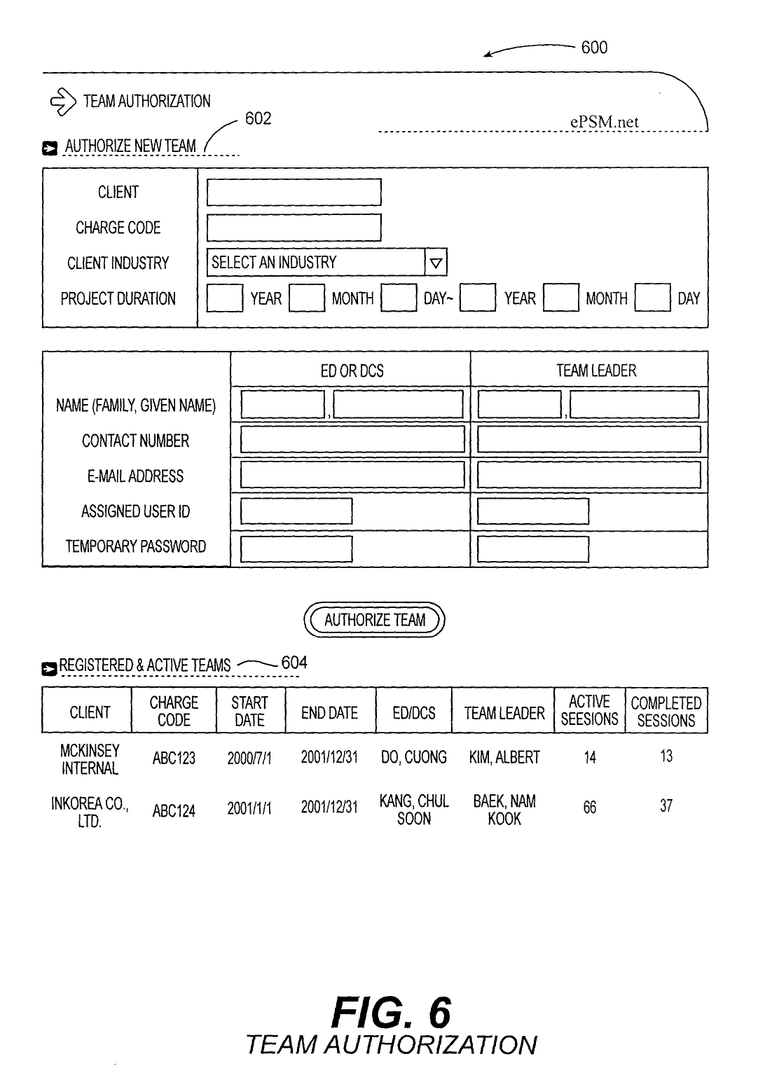

As discussed above, the starting point in implementing the preferred embodiment of the present invention is to grant access to the system to one or more team leaders. FIG. 6 shows a Team Authorization Input Screen 600, as may be displayed on a CRT, as an example of one possible user interface for this step. The Team Authorization Input Screen 600 is used by a website administrator to grant access to a specific team, which, in the preferred embodiment, has up to 2 leaders. As can be seen in FIG. 6, this screen provides a mechanism for authorizing new teams (see reference number 602) and a way to view registered and active teams, reference number 604.

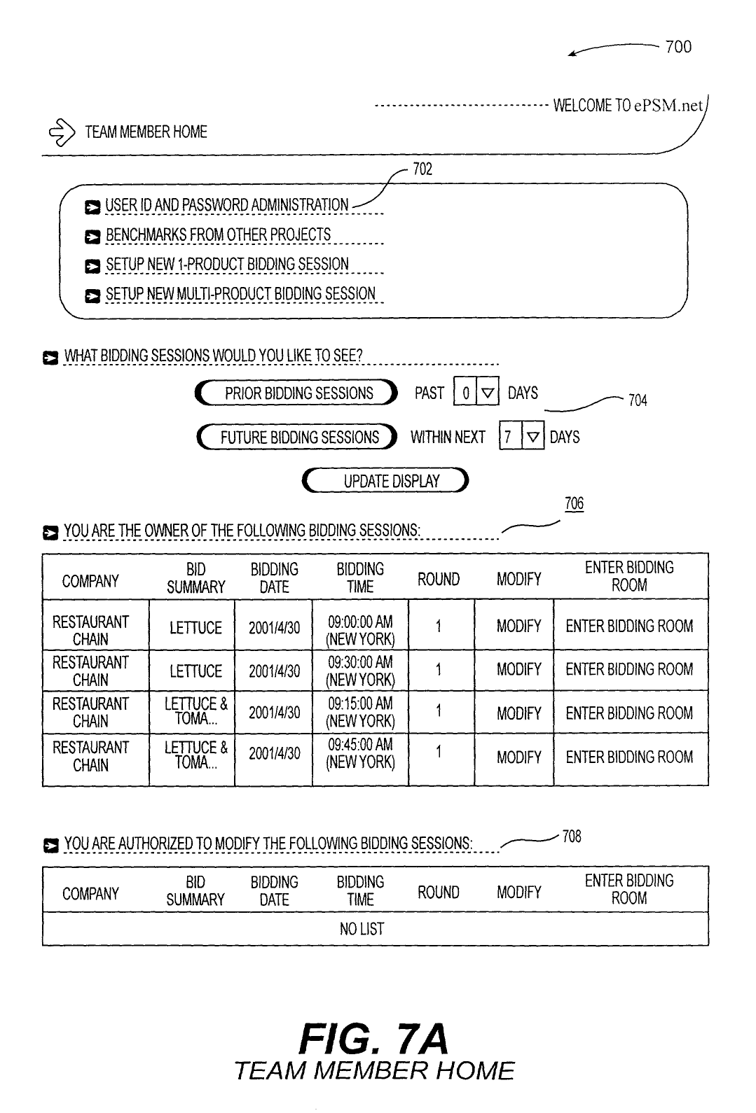

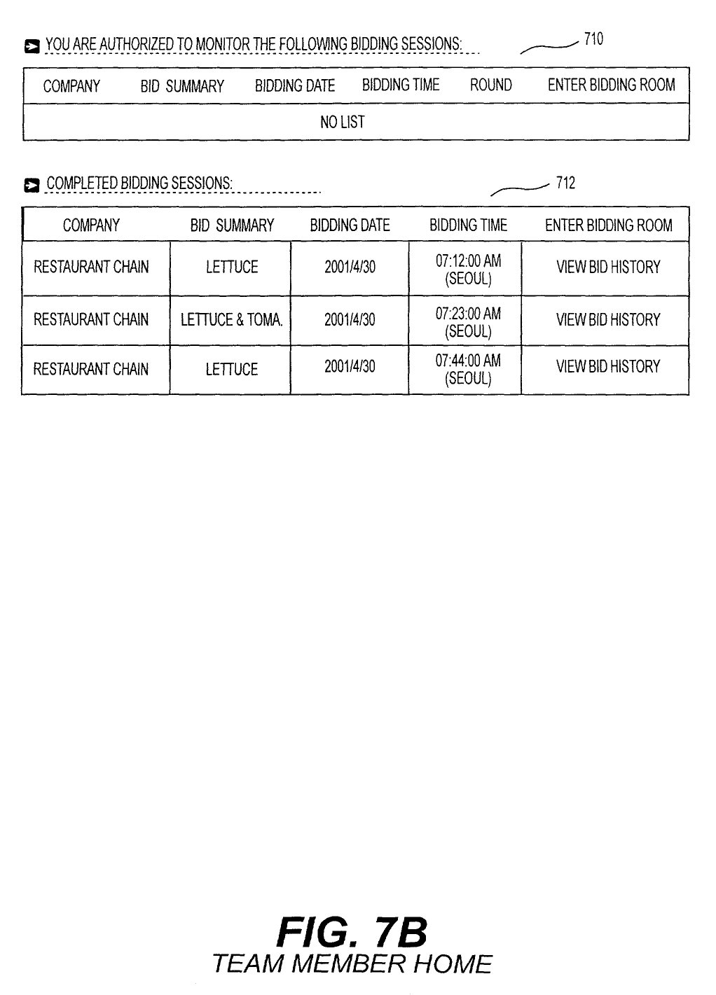

Once the website administrator has granted team leaders access to the system, they may, in the preferred embodiment, view a Team Home Screen 700, as depicted by FIG. 7. As can be seen in FIG. 7, the Team Home Screen 700 serves as the main access point for all of the functions available to team members in the preferred embodiment of the present invention. From this screen, the team member may choose from a variety of bidding session administrative functions by selecting certain buttons displayed on the screen. The team member, may, for example, authorize new team members and pre-qualified bidders, see benchmarks from other bidding sessions, or set up new single-product or multi-product bidding sessions by selecting one of the links in the section indicated by reference 702 in FIG. 7. The team member may also view information concerning previously-created bidding sessions by selecting one of the links in the section of the screen indicated by reference number 704 of Team Home Screen 700. In the preferred embodiment, bidding sessions are organized into three groups based on the user's access rights and displayed accordingly. For example, all of the bidding sessions for which the team member is an owner (a team member who creates a bidding session is considered the bidding session's owner) are shown in the section of Team Home Screen 700 designated by 706. Likewise, the bidding sessions that a team member may modify can be shown at section 708, and the bidding sessions that the team member may monitor may be shown at section 710.

In the preferred embodiment, the number of bidding sessions to be displayed is determined by the date range specified in section 704 of Team Home Screen 700. The user can, for example, display all of the bidding sessions completed within a certain number of days, with the default being zero (section 712). The user can also display bidding sessions to be completed in the future by specifying a number of days to look ahead. In the preferred embodiment, the default number of days to look ahead is seven.

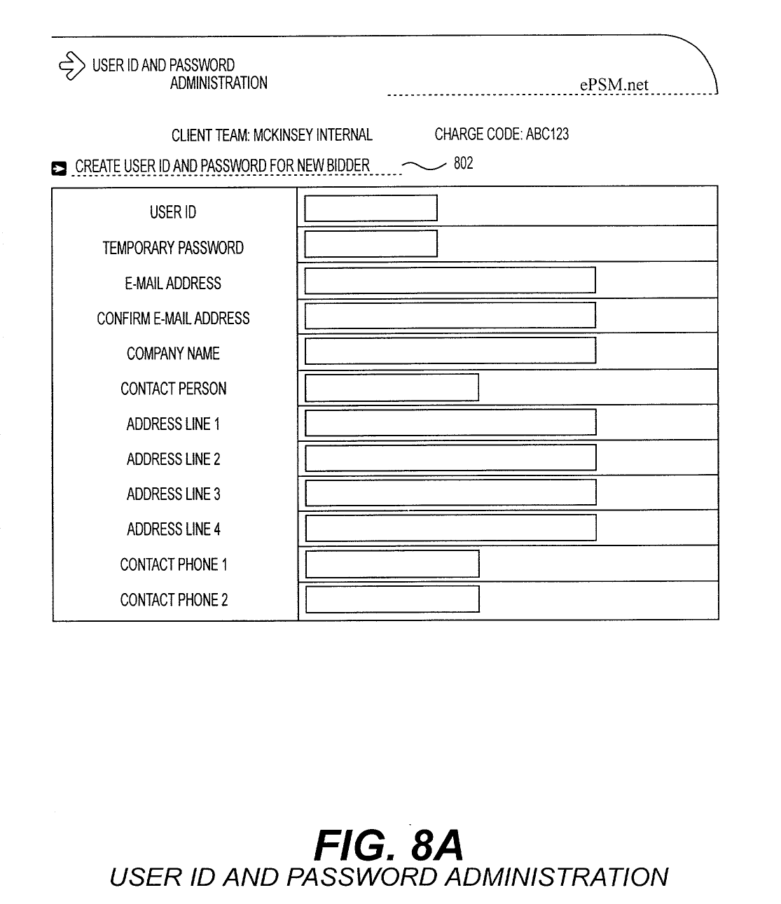

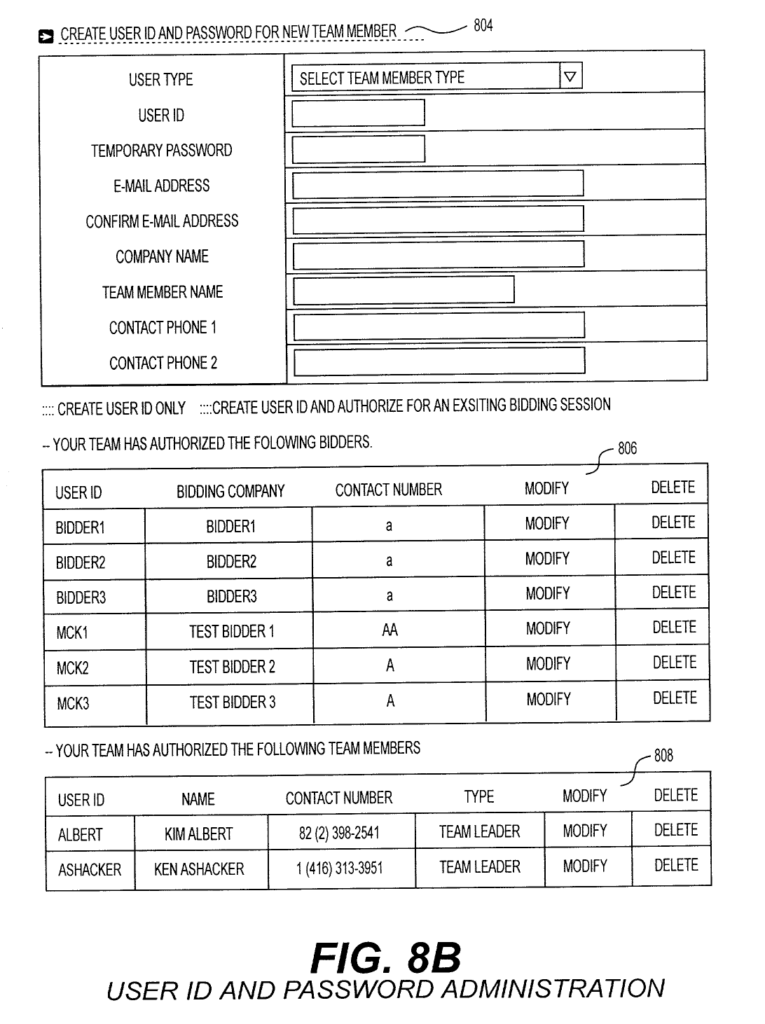

In a preferred embodiment of the present invention, the team leader may authorize other team members and pre-qualified bidders through the use of a computer screen resembling FIG. 8. By giving team leaders the authority to grant access to other users, the bidding session administrator is relieved of much of the burden of administration. Through the screen depicted in FIG. 8, for example, team leaders can access additional screens to perform a number of administrative functions, such as creating a new User ID and password for a new bidder (see section 802 of FIG. 8), create a new User ID and password for a new team member (section 804), view the list of authorized bidders (section 806), or view the list of authorized team members (section 808).

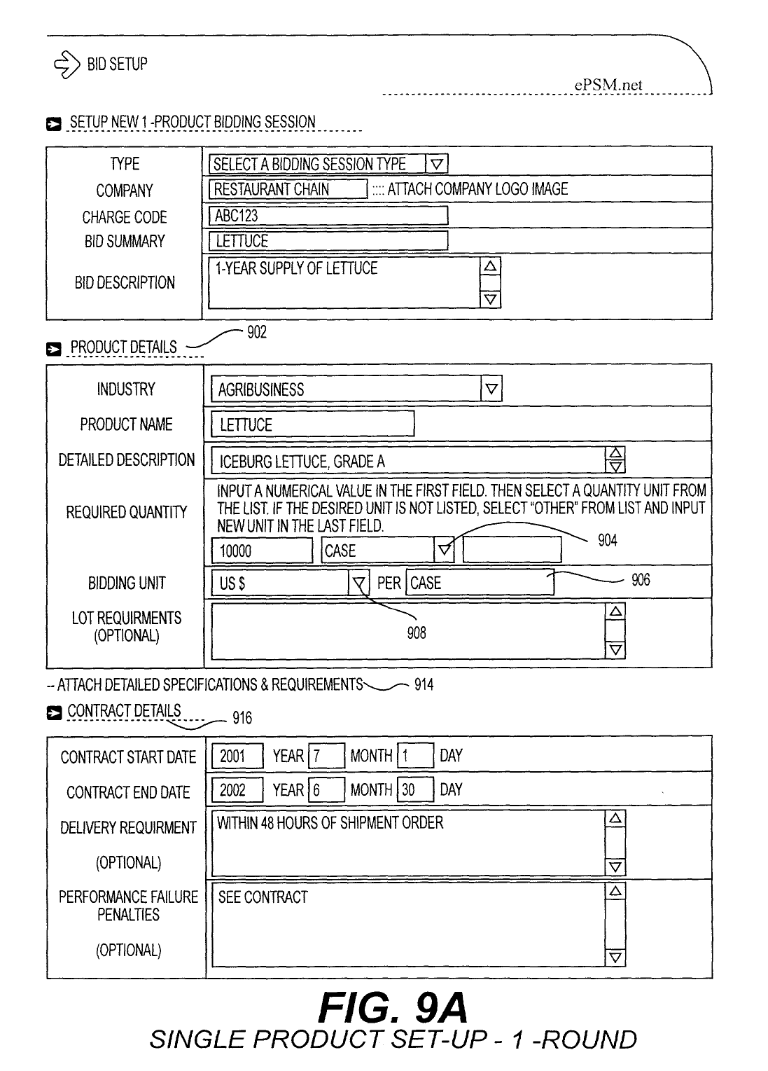

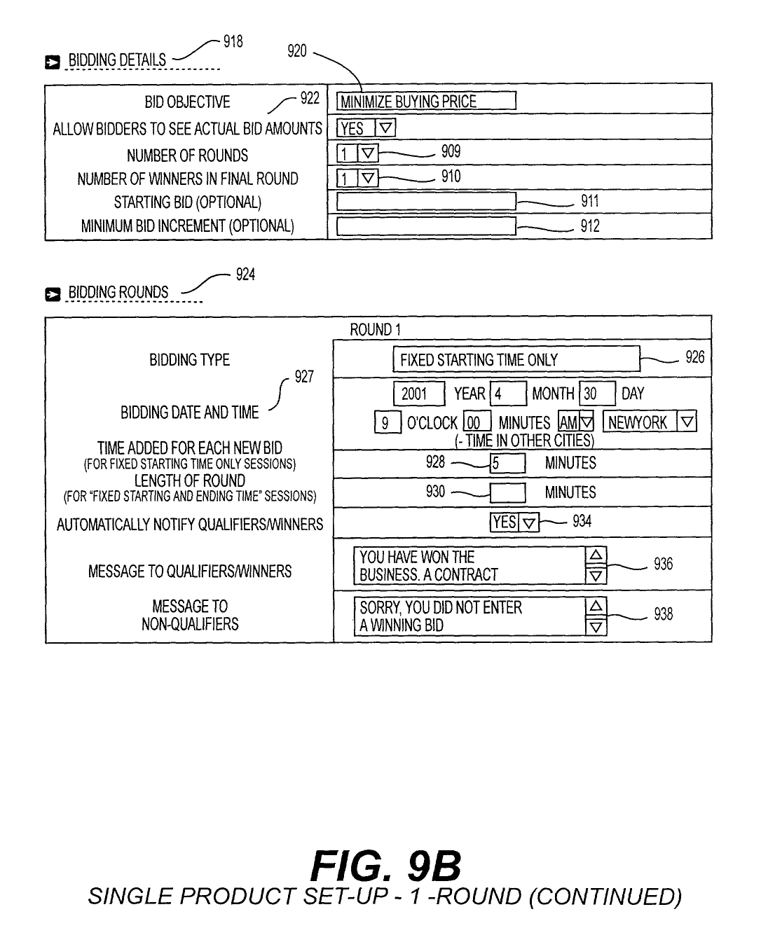

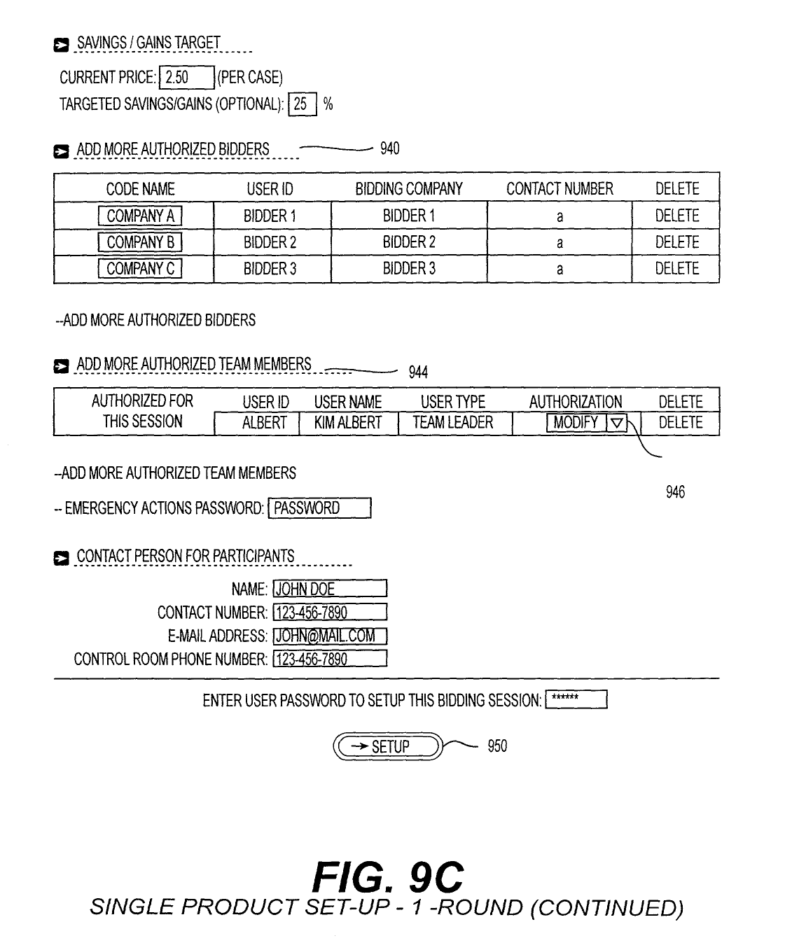

A team member can set up a single-product, single-round bidding session by using a screen like the one depicted in FIGS. 9A and 9B. In a preferred embodiment, this screen allows the team member to specify all aspects of conducting the bidding session. A field (indicated in FIG. 9A by reference number 902) is provided on this screen, for example, for the user to enter details about the product being put to bid (e.g., product, quantity, etc.) In a preferred embodiment, the user's selection from the “Required Quantity” drop-down menu 904 is automatically displayed in the “Bidding Unit” field 906 after the word “per.” The user has the option of specifying the starting price and minimum bid increments bidders must observe, as depicted in FIG. 9A by reference numbers 911 and 912. The “Attach detailed specifications & requirements” link 914 functions to allow the user to attach a file to provide additional details about the product. The user may also specify details about the contract (e.g., duration, delivery requirements, performance penalties, etc.) in the Contract Details section of the screen (see reference number 916).

Bidding details (e.g., date and time, bidding objective, fixed vs. variable ending time, etc.) are defined for the bidding session by completing the section entitled “Bidding Details” 918. The “Bid objective” drop down menu (920 on FIG. 9A) indicates the direction of the bidding. “Minimize buying price” indicates that the objective is to get to the lowest bid (i.e., we are helping a buyer purchase something at the lowest price), and “Maximize selling price” indicates that the objective is to get to the highest bid. The “Allow bidders to see actual bid amounts” menu 922 is a “yes-no” pop-up menu that determines whether the actual prices submitted by bidders will be shown to the bidders during the bidding session.

Bidding round parameters (e.g., number of rounds, number of qualifiers for each round, number of winners, date and time for subsequent rounds, etc.) can be entered in the “Bidding Details” section (918 in FIG. 9A) and the “Bidding Rounds” section 924 of this screen. In a preferred embodiment, users have the flexibility of conducting sessions that extend to multiple rounds (e.g., the lowest few bidders from one round are invited to participate in a second round of bidding). A “Number of rounds” field 909 indicates how many rounds will take place in a bidding session. In a preferred embodiment, the default is 1. If there is more than 1 round, a “Number of winners in final round” field 910 determines how many bidders will be asked to join the final round.

Under the “Bidding Rounds” section 924, the “Bidding Type” menu 926 determines whether the session has an ending time. A “Time added for each new bid” field 928 determines the amount of time to extend the bidding session. If “Fixed start time and variable ending time” is selected on menu 926, then the “Time added for each new bid” field 928 is activated and the “Length of round” field 930 is deactivated. If “Fixed start and ending times” is selected through menu 926, then the “Length of round” field 930 is activated and the “Time added for each new bid” field 928 is deactivated.

A “Bidding date and time” field (927 in FIG. 9A) determines when the round will take place. The “Automatically notify qualifiers/winners” field 934 determines whether bidders will automatically receive a message at the end of a round indicating if they have won or qualified for the next round. The “Message to qualifiers/winners” field 936 and “Message to non-qualifiers” field 938 provide the text to display if the “Automatically notify qualifiers” field 934 is activated.

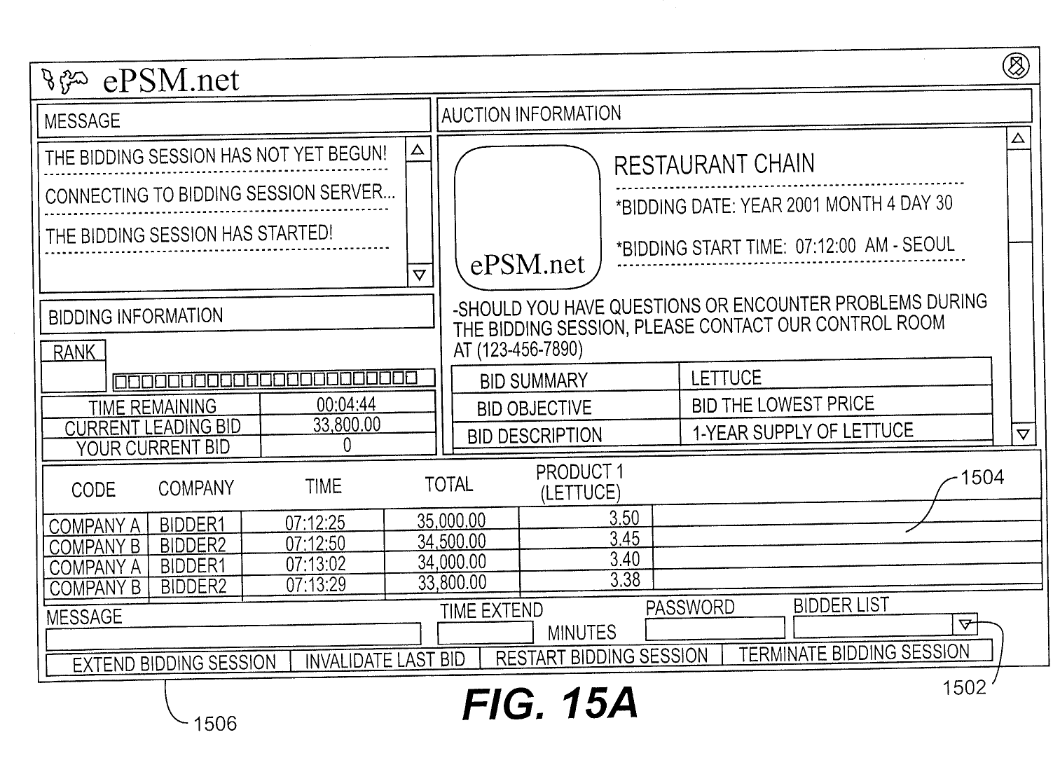

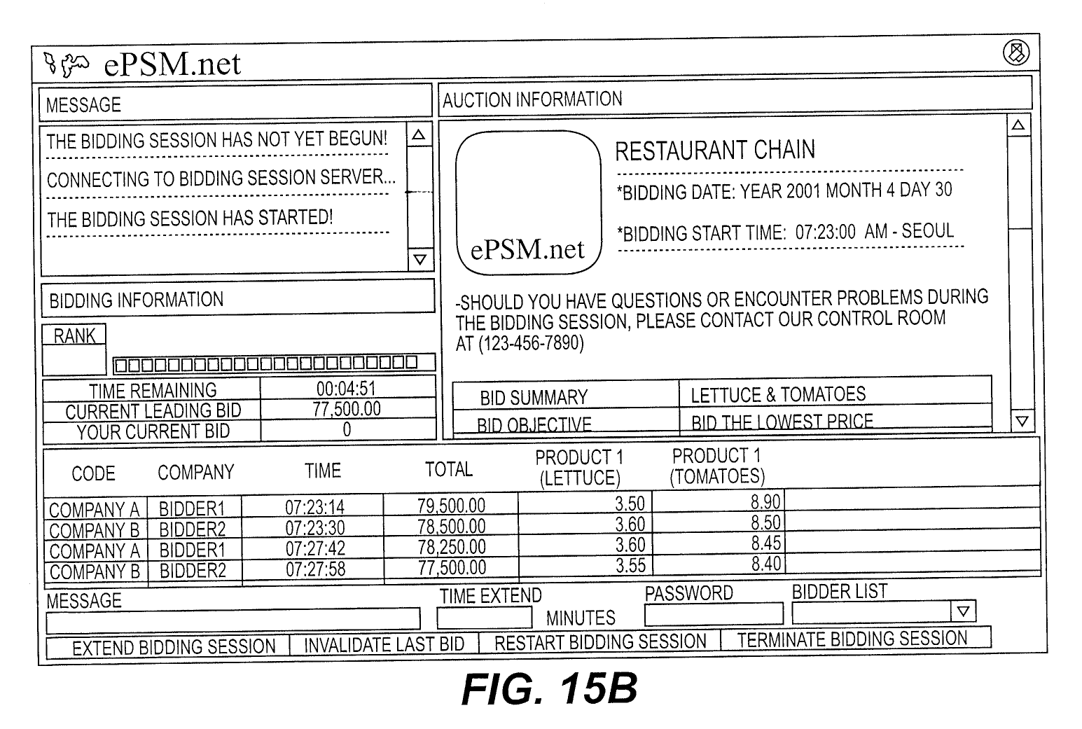

With reference now to FIG. 9B, the user authorizes participants by clicking on the “Add more authorized bidders” link 940, which causes the system to search user database to retrieve the bidding company name, user name, and/or contact number for the bidders already pre-qualified by the team. The user selects from among pre-qualified bidders to authorize their participation in this bidding session. To allow access to this bidding session for other team members, the user clicks on the “Add more authorized team members” field 944, which causes the system to display a list of team members with access to the system. The authorization drop-down menu 946 is used to provide access and modify the rights of team members. If “Modify” is selected, team members are allowed to update the bidding session. If “Monitor” is selected, team members are allowed to preview the session's settings and enter the bidding room through the “Bidding Monitor” page (discussed below with reference to FIGS. 15A and 15B).

To complete the setup for a single-product, single round bidding session, a “Setup” button 950 is provided at the end of this screen. When the user enters the password and clicks on “Setup” 950, the system (1) verifies that all required fields have been entered correctly; store the bidding session information in the system's database; and (3) sends an email to each person authorized to bid in the bidding session. In a preferred embodiment, this email will provide all the appropriate information about the bidding session and also reminds the person of their User ID and password to access the site.

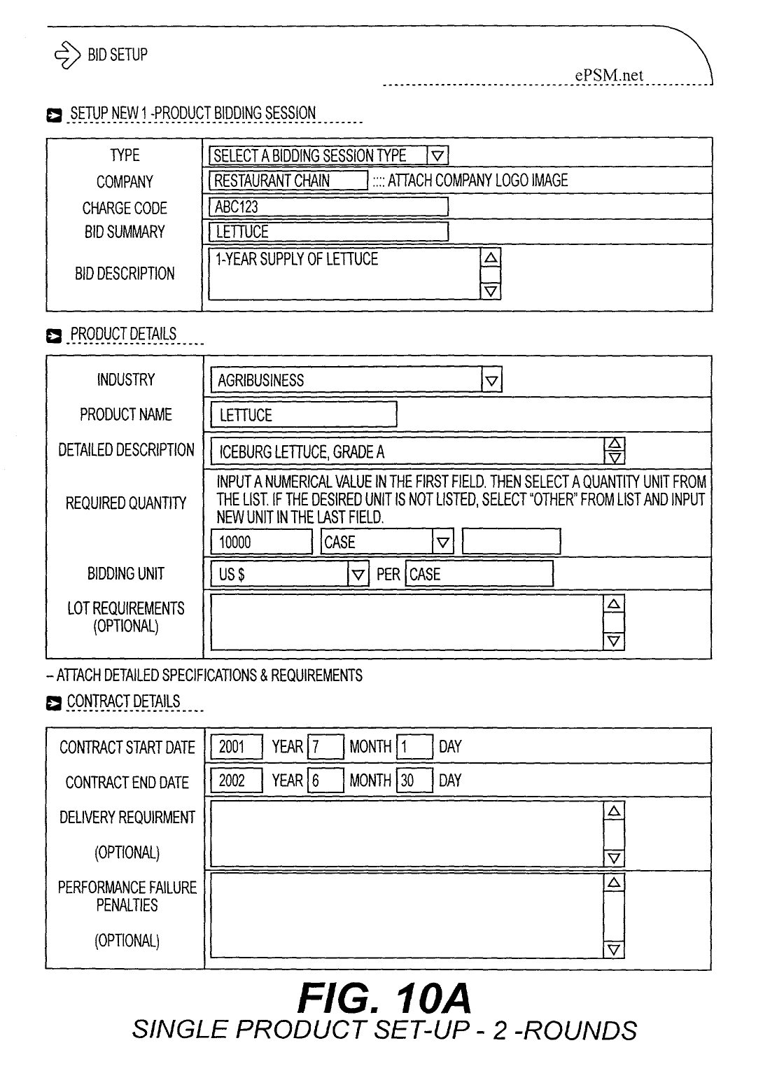

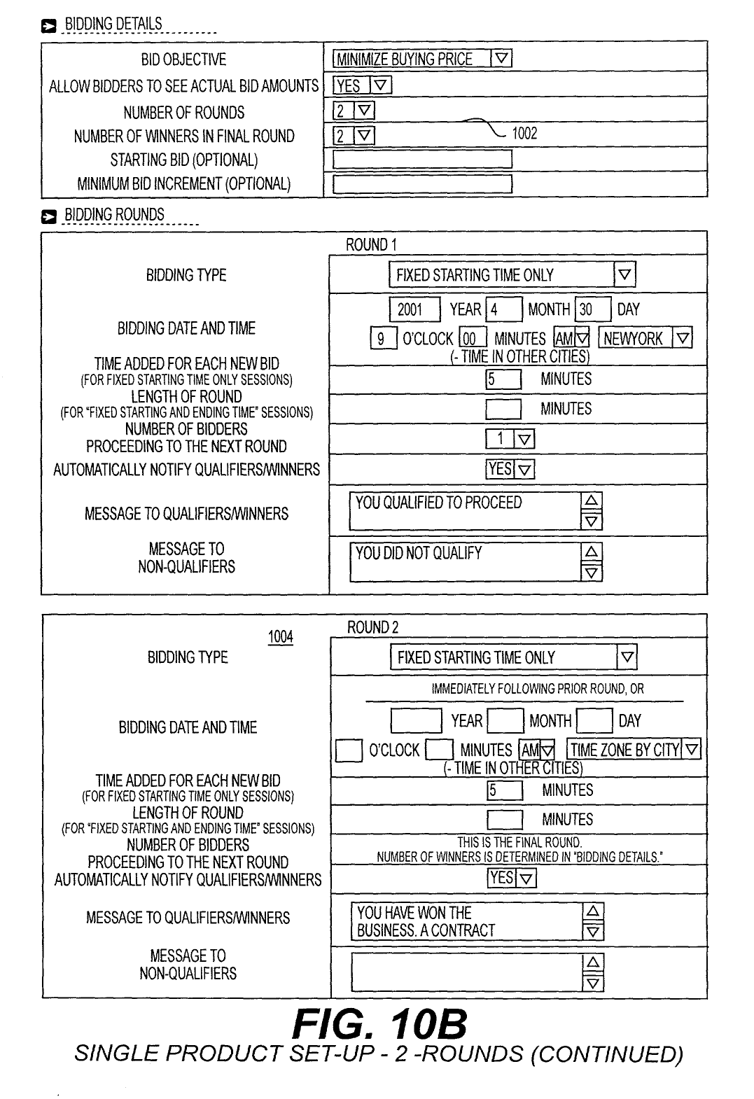

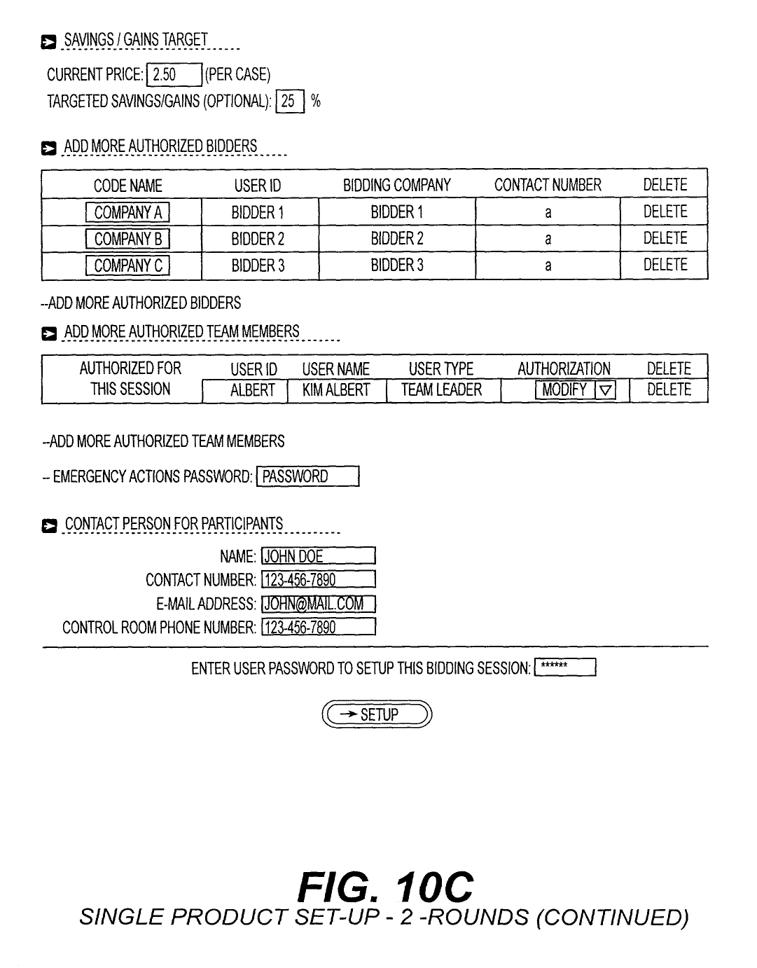

A single-product, multiple-round bidding session may be created in a preferred embodiment by using a setup screen similar to the one depicted in FIGS. 10A and 10B. This screen is essentially the same as the exemplary single-product, single-round screen depicted in FIGS. 9A and 9B, except that this screen provides the ability to input details on more than one round. When the number of rounds is set to be two or more (reference 909 in FIG. 9A), the system adds a section to allow the user to specify how subsequent rounds will be conducted (reference number 1002 in FIG. 10B). Two options are available for specifying when round 2 will be conducted. If a specific date and time is provided, the system automatically creates another bidding session, which will begin at the specified date and time, and which will have same settings as the prior round. But only the bidders who qualify are allowed to proceed. If, on the other hand, “Immediately following the prior” is selected, the system automatically starts another bidding session with same settings, immediately after prior round. Again, only qualified bidders will be allowed to proceed.

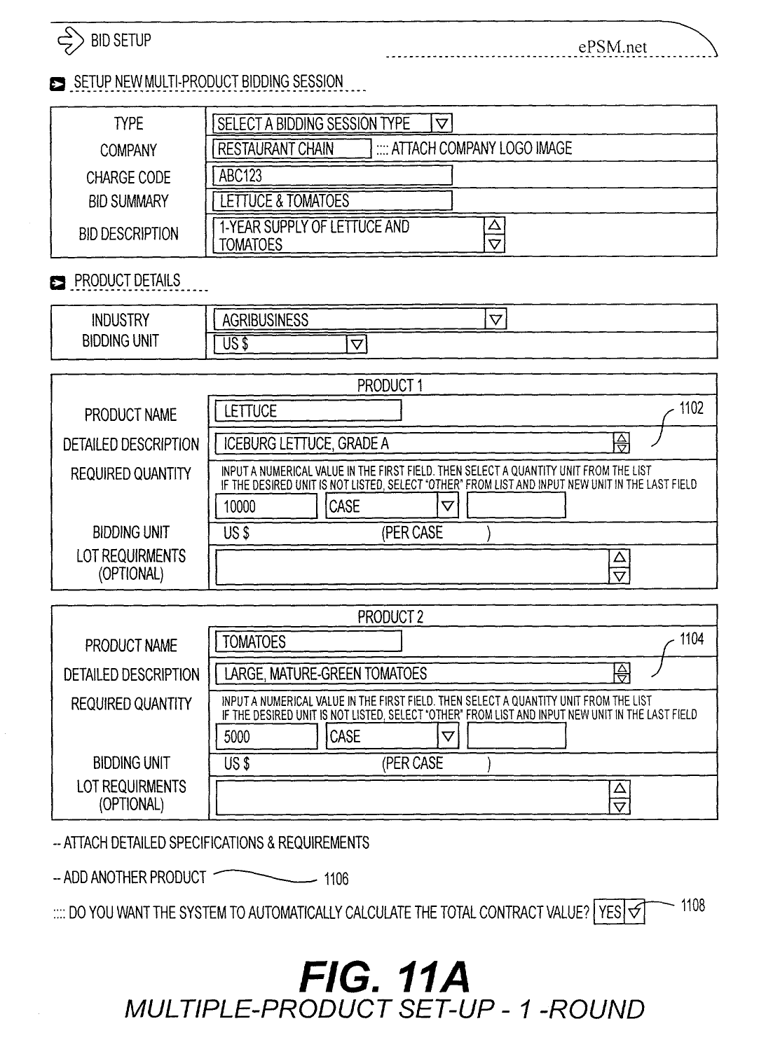

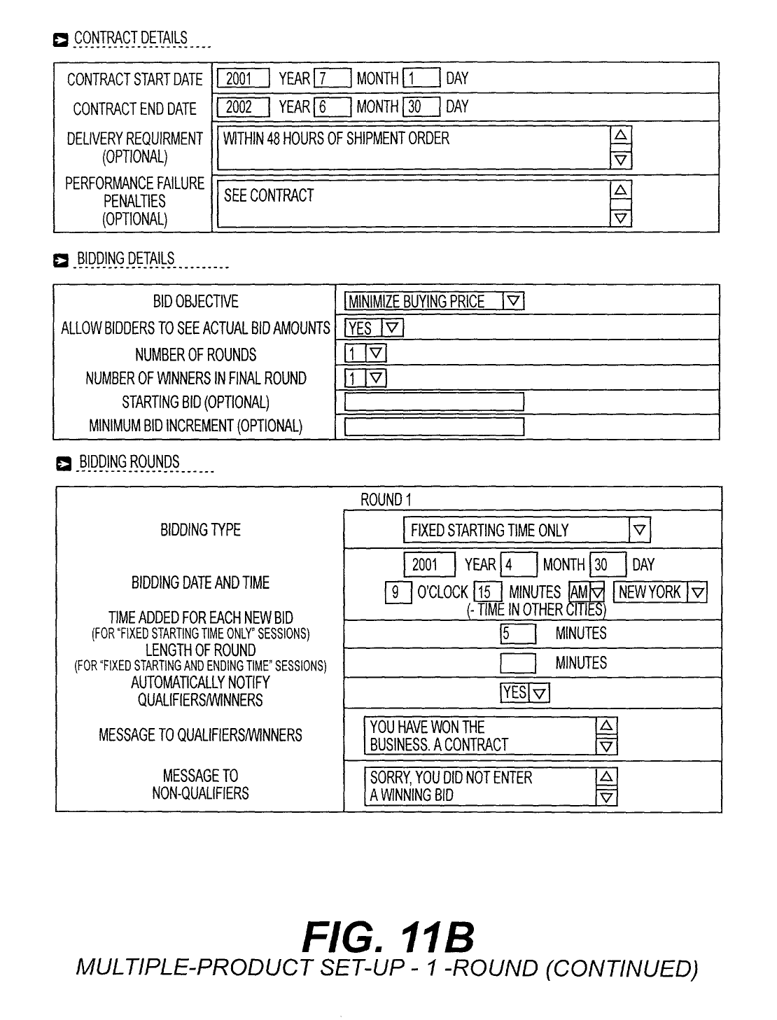

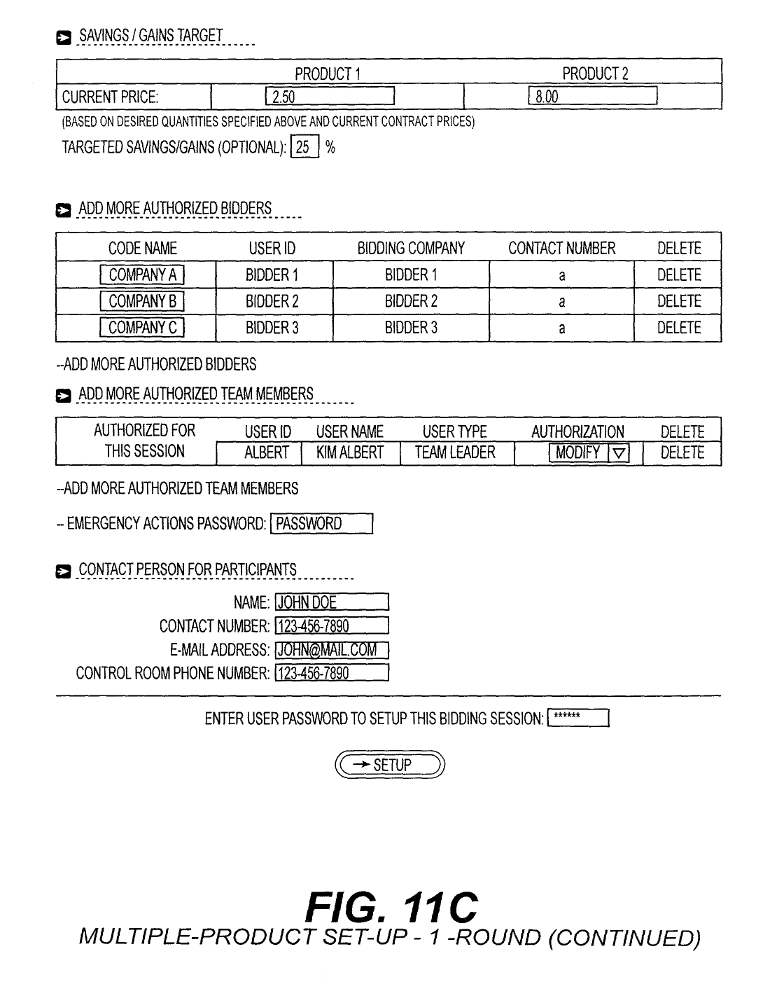

A multi-product, single-round bidding session may be created in a preferred embodiment of the present invention via a screen resembling the one depicted in FIGS. 11A and 11B. This screen is essentially the same as the exemplary single-product screens depicted in FIGS. 9A and 9B, except that this screen contains input fields to specify details on more than one product (see the dialog boxes indicated by reference numbers 1102 and 1104 in FIG. 11A), with the default being 2 products. Clicking on the “Add another product” field 1106 brings up another dialog box to add another product.

An additional element contained on the multi-product bidding screen is a drop-down menu 1108 to specify whether the system should automatically calculate the total contract value. In one embodiment, there are two options for determining the total value of the contract when bidding for multiple products. If the user selects “yes” for the “Do you want the system to calculate the total contract value” field 1108, then the system will accept separate bids for each product, and calculate the total amount for the contract automatically. If the user selects “no” for the “Do you want the system to calculate the total contract value” field 1108, then the system will accept bids for the total contract. In this mode, component bids for the individual products may be accepted for informational purposes only.

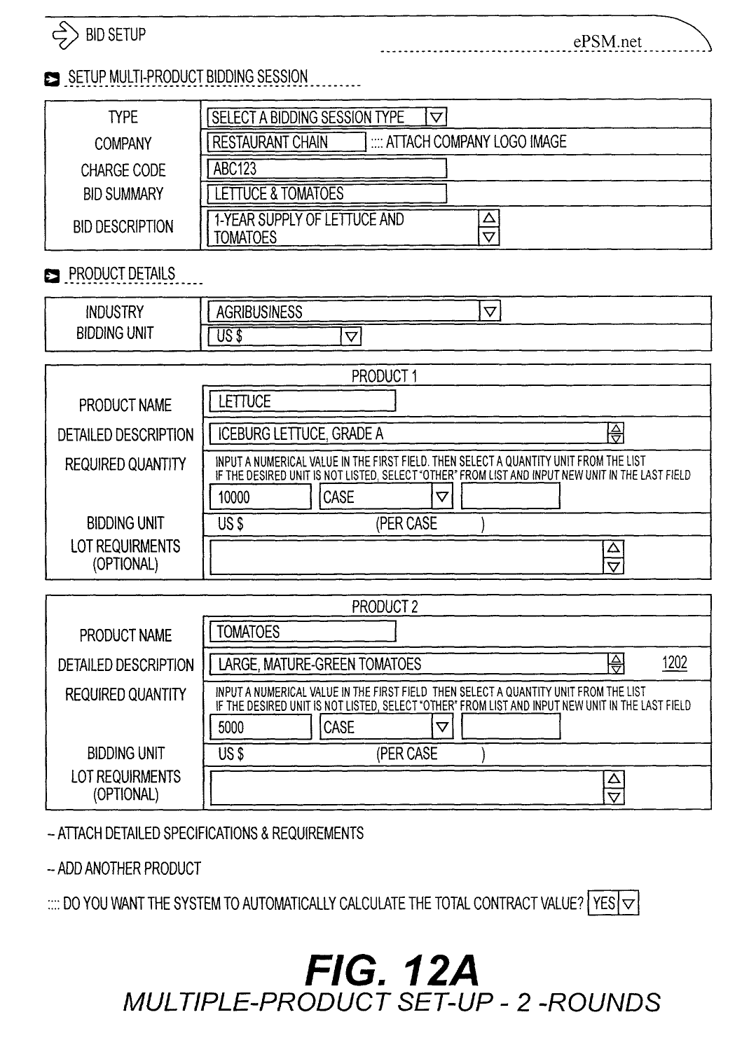

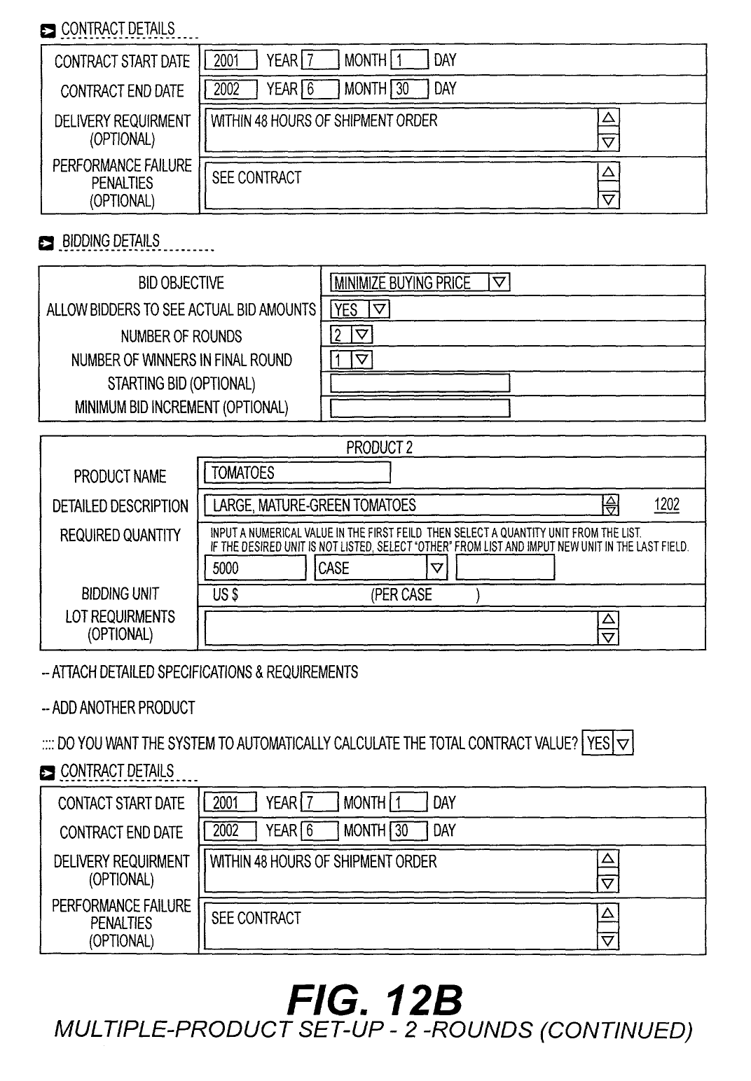

FIGS. 12A and 12B depict an exemplary user interface screen for setting up a multiple product, double-round bidding session. This screen is essentially identical to the multiple-product, single-round setup screen shown in FIGS. 11A and 11B, except that it contains a dialog box (indicated by reference number 1202 in FIG. 12B) for inputting details for an additional round of bidding.

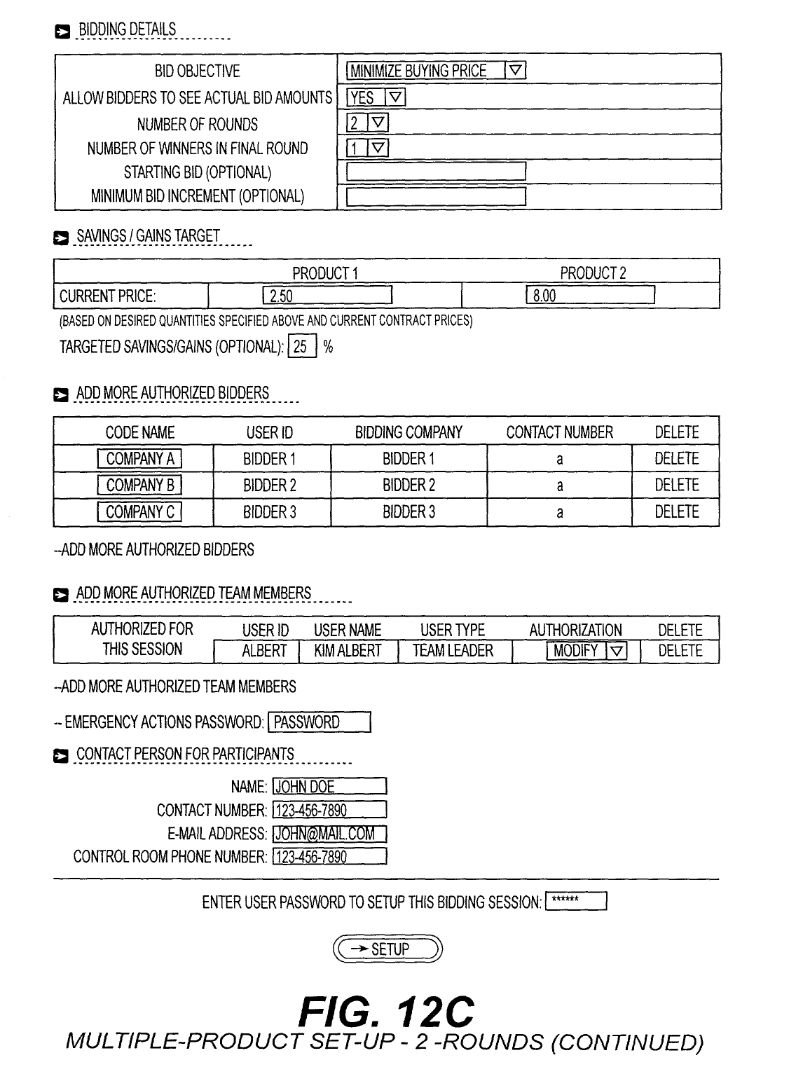

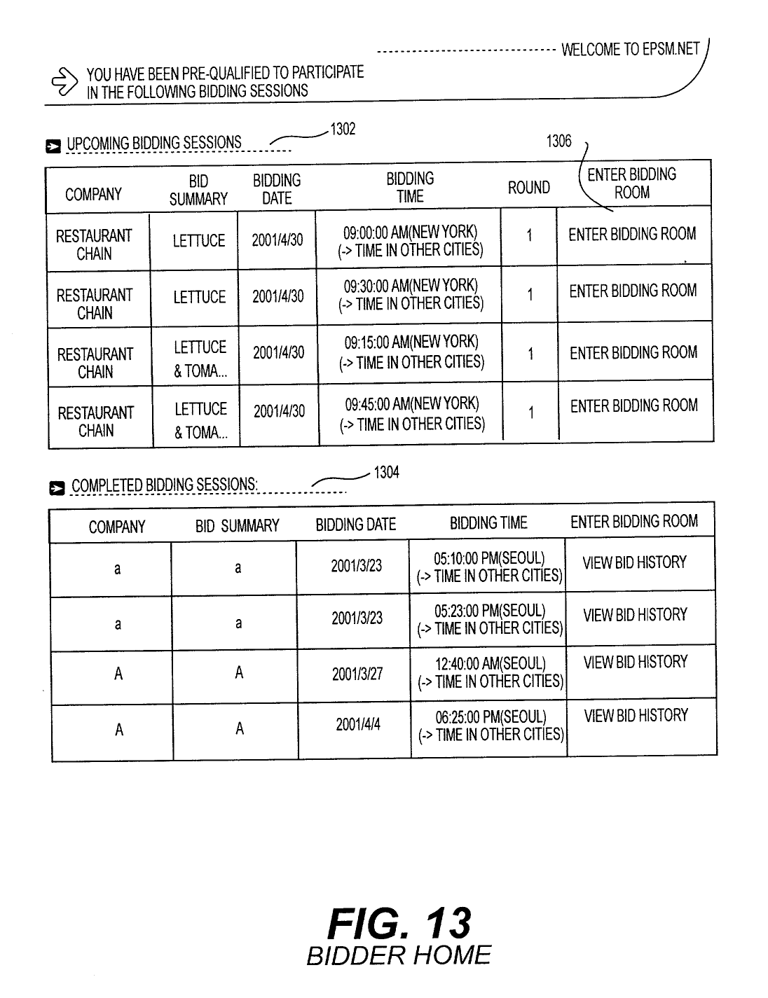

When an authorized bidder logs into the system, he or she is presented with the “Bidder Home” screen depicted in FIG. 13. This screen presents future bidding sessions in which the bidder is invited to participate (see the section indicated by reference number 1302). The screen also provides bidding sessions that have already been completed, as depicted in 1304. This screen is the main access point for all the bidding sessions and tools available to bidders. Here, the bidder can access and view numerous details about each bidding session.

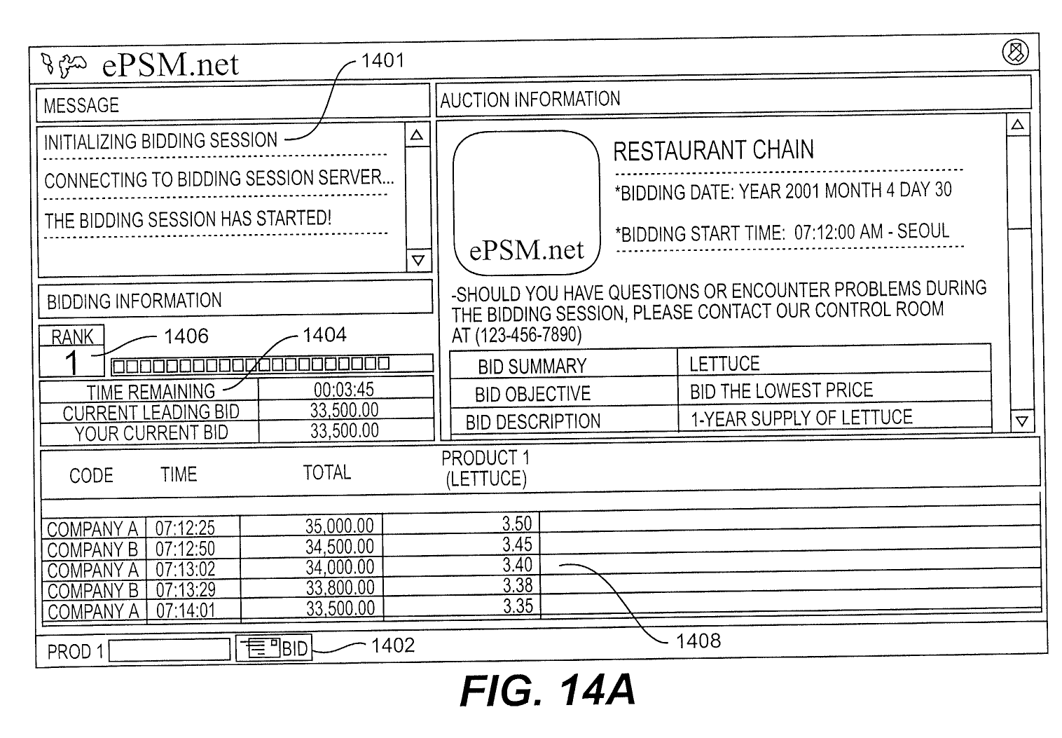

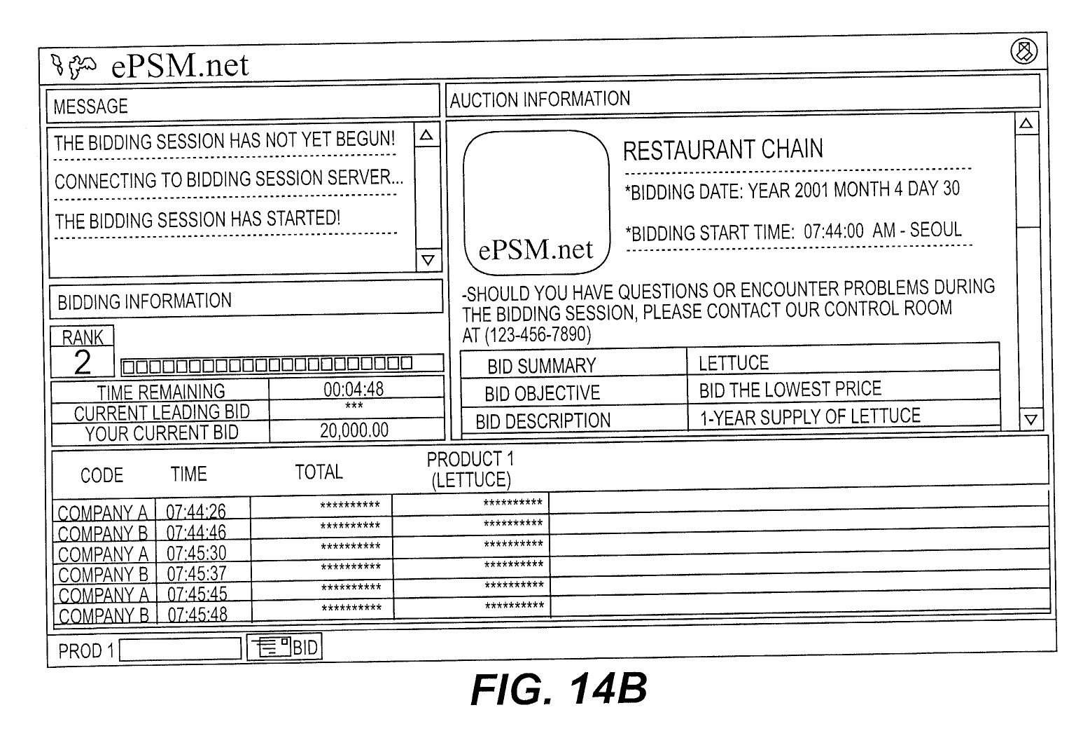

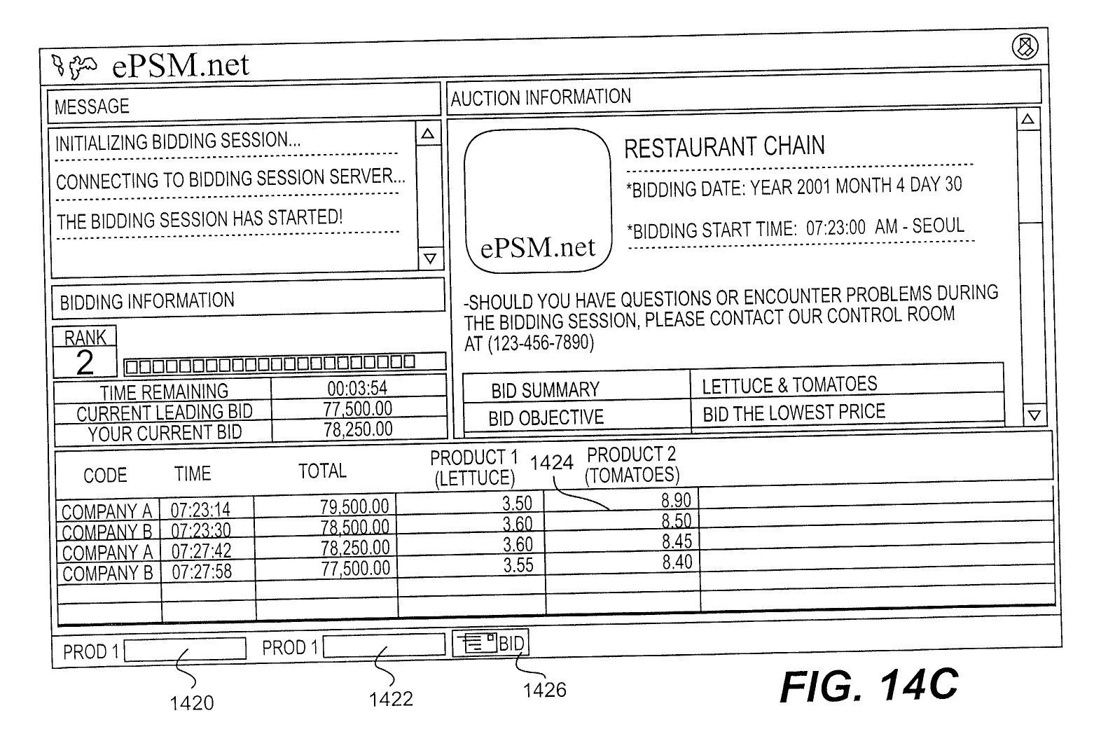

At the appointed date and time, the bidder can participate in a bidding session by clicking on “Enter bidding room” 1306 in FIG. 13. He or she is presented with one of the “bidding rooms” depicted by FIGS. 14A, 14B and 14C. FIG. 14A shows a bidding room for a single-product bidding session. FIG. 14B shows a single-product bidding room for a bidding session operating in “price blind” mode. And FIG. 14C shows a bidding room for multiple products. In a preferred embodiment, if a bidder enters a bidding room prior to the bidding time, the indicator displays “Bidding will start in” and the amount of time until the start of bidding.

In a preferred embodiment, a bid is entered by typing a value in the bid field and pressing the “Bid” button (depicted, for example, as 1402 in FIG. 14A). When a bidder enters a new bid, the system checks the validity of the bid. If a value was entered in the “Starting Bid” field (911 in FIG. 9A) during the setup process and the “Bid objective” field (920 in FIG. 9A) is set to “Minimize buying price,” then the first bid must be less than or equal to value specified in “Starting Bid” field 911. If the “Bid Objective” field 920 was set to “Maximize selling price,” then the value entered must be greater than or equal to the value specified in the “Starting Bid” field 911 during setup.

Next, the system checks the validity of the new subsequent bid with respect to prior bids based on the value specified in the “Minimum Bid Increment” field 912 during setup. If the “Bid objective” field 920 is set to “Minimize buying price,” then the new bid is valid only if the new bid is less than or equal to the prior bid minus the Minimum bid increment. If the “Bid objective” field was set to “Maximize selling price,” then the bid is valid only if the new bid is greater than or equal to the prior bid plus the Minimum bid increment. If a value was not specified for the “Minimum bid increment” field 912 during setup, then the default minimum bid increment is 0.01. If the bid is invalid, an error message is displayed to the bidder in the “Message” section (depicted in FIG. 14A as 1401) of the bidding room screen.

After validating the new bid, the “Time remaining” indicator 1404 is reset to the value specified in the “Time added for each new bid” field (928 in FIG. 9A) during the bid session setup. The system updates the “Rank” field 1406 to specify how the bidder's bid ranks compared with the bids already received from other bidders. Information about the new bid and time remaining is displayed in the Bidding Activity area (1408 in FIG. 14A). All of these updates happen simultaneously and in real-time.

The bidding room used by bidders for multiple products is similar to the single-product bidding room except that it has input and display fields (see 1420, 1422 and 1424 in FIG. 14C) for each product and the total contract value. In a preferred embodiment, the multi-product bidding room will function as follows with respect to bidding. Whenever a Bid button, such a 1426 in FIG. 14C, is selected and the value specified in the “Do you want the system to automatically calculate the contract value” field (1108 in FIG. 11A) is “Yes,” the system calculates the total contract value by summing the product of each product's required quantity and the new bid price. The system then checks the validity of the new bid using the total contract value and the all rules specified earlier for the single product bidding room. Whenever a Bid button, depicted as 1426 in FIG. 14A, is selected and the value specified in the “Do you want the system to automatically calculate the contract value” field (1108 in FIG. 11A) is “No,” then the system checks the validity of the total contract value and the all rules specified earlier for the single product bidding room without doing any calculations to total the bid value.

Team members can monitor the progress of a single-product online bidding session by using a bidding session monitor that resembles FIGS. 15A and 15B. The bidding monitor screen may, in a preferred embodiment, contain several additional features. First, a “Bidder List” section is provided to display the bidders who have entered the bidding room (see 1502 in FIG. 15A). Also, the “Bidders List” is continually updated to account for situations where bidders may leave and reenter the bidding room. The “bidding activity” section displays the current bid and all prior bids in a scrollable area (see 1504 in FIG. 15A).

Since things may go wrong during a session that may require remedial steps, an “emergency actions” section allows for certain actions to be taken to handle emergencies as depicted by 1506 in FIG. 15A. Some of he emergency actions would include, for example: extending the bidding time, which allows the user to add extra time to bidding session (e.g., in situations where bidding is delayed because bidders are late entering the bidding room), invalidating a last bid, which allows the team to eliminate an erroneously entered value that was too low (e.g., bidder calls the control room and indicates that he or she entered a value with a missing decimal point).

If the last bid is invalidated, the system removes the last bid from the Bidding Activity table, resets the bidding session timer, and sends a message to participating bidders. A team member may also restart a bidding session, which causes the system to discard all bids entered to that point and restart the bidding session from the beginning. When this occurs, a message to bidders entered by user is displayed in the message section for all participating bidders. And finally, a team member may terminate a bidding session in mid-stream.

The above-described preferred embodiments are intended to illustrate the principles of the invention, but not to limit its scope. Various other embodiments, modifications and equivalents to these preferred embodiments may occur to those skilled in the art upon reading the present disclosure or practicing the claimed invention. Such variations, modifications and equivalents are intended to come within the scope of the invention and the appended claims.

What I claim is:

1. A method of conducting a bidding session, comprising the steps of:
establishing a communications channel between a bidding session server and a web browser residing on a remote terminal;
transmitting bidding session status information from said bidding session server to said web browser via said communications channel;
receiving a bid from said web browser via said communications channel; and
in response to receiving said bid, transmitting an update of said bidding session status information to at least one web browser residing on at least one remote terminal, wherein said update has not been requested by said at least one web browser.

2. The method of claim 1, wherein the duration of said bidding session is automatically extended a predetermined period of time in response to the receipt of said bid by said bidding session server.

3. The method of claim 2, wherein said predetermined period of time is specified by a bidding session supervisor component.

4. The method of claim 1, wherein said bidding session status information comprises data representative of at least one of the following:
a bidding session sponsor,
a bidding session objective,
a bidding session format,
a bidding session date,
a bidding session timer,
a product being put to bid,
a product specification,
a required quantity,
a contract duration,
a contract delivery requirement,
a contract performance penalty,
a starting bid,
a last bid,
a bidding rank,
a bidding unit,
a minimum bid increment,
a start time for bidding,
an end time for bidding,
a new bid time extension value,
whether bid values are hidden,
a current bidding round number,
a number of total bidding rounds,
a number of bidders,
a bidder identification, and
a bidding history.

5. The method of claim 1, wherein said step of transmitting an update occurs in real time relative to said step of receiving a bid.

6. The method of claim 1, wherein said at least one web browser is the same as said web browser.

7. The method of claim 1, wherein said update does not include the value of said bid.

8. The method of claim 1, further comprising the step of qualifying bidders to participate in said bidding session.

9. The method of claim 1, further comprising the step of qualifying a subset of bidders to participate in at least one additional round of bidding;

10. The method of claim 1, further comprising the step of inviting bidders to participate in said bidding session.

11. The method of claim 1, wherein the step of transmitting said update comprises transmitting data representative of:
an identity of a bidder;
a time said bid was received by said bidding session server;
the value of said bid;
a ranking of all bids received by said bidding session server; and
a time remaining in said bidding session.

12. The method of claim 1, wherein said bidding session server and said remote terminal are located on opposite sides of a firewall.

13. The method of claim 1, wherein said connection establishing step comprises:
transmitting a connection builder from said bidding session server to a random access memory in said remote terminal;
sending a request to said connection builder to identify an external communications channel for said remote terminal; and
opening said external communications channel.

14. A method of conducting a bidding session, comprising the steps of:
establishing a communications channel between a bidding session server and a web browser residing on a remote terminal located on the opposite side of a firewall;
transmitting bidding session status information to said web browser through said firewall via said communications channel;
receiving a bid from said web browser via said communications channel;
extending the duration of said bidding session in response to receiving said bid;
transmitting an update of said bidding session status information to at least one web browser residing on at least one remote terminal, wherein said update has not been requested by said at least one web browser;
qualifying a subset of bidders to participate in at least one additional round of bidding;
wherein said update does not include the value of said bid; and
wherein said bidding session status information comprises at least two kinds of products to be put to bid simultaneously.

15. A method for conducting bidding sessions for a plurality of clients, comprising the steps of:
providing a memory area, coupled to a centralized bidding session server infrastructure, for storing bidding session-related data for each of said plurality of clients;
providing a security means for preventing unauthorized access to said bidding session-related data;
under control of said security means, providing authorized access to said bidding session-related data for one of said plurality of clients by a bidding session administrator, wherein said authorized access does not allow said bidding session administrator to access said bidding session-related data for another of said plurality of clients; and
wherein said bidding session administrator sets up a bidding session on said centralized bidding session server infrastructure on behalf of said one of said plurality of clients.

16. The method of claim 15, wherein said step of setting up a bidding session comprises:
providing authorized access to said bidding session by qualified participants; and
specifying a set of bidding session details.

17. The method of claim 15, wherein said set of bidding session details comprises one or more of the following:
a bidding session sponsor,
a bidding session objective,
a bidding session format,
a bidding session date,
a bidding session timer,
a product being put to bid,
a product specification,
a required quantity,
a contract duration,
a contract delivery requirement,
a contract performance penalty,
a starting bid,
a bidding unit,
a minimum bid increment,
a start time for bidding,
an end time for bidding,
a new bid time extension value,
whether bid values are hidden,
a number of total bidding rounds,
a maximum number of bidders and
a minimum number of bidders.

18. The method of claim 15, further comprising the step of providing benchmark information for a plurality of bidding sessions conducted on said centralized bidding session infrastructure.

19. The method of claim 18, wherein said benchmark information comprises data representative of:
an average gain achieved by others in a particular industry;
an average gain achieved by others for a particular product; and
a bidding history for a product.

20. The method of claim 18, wherein said benchmark information comprises data representative of:
an average savings achieved by others in a particular industry;
an average savings achieved by others for a product; and
a bidding history for a product.

21. The method of claim 18, wherein said benchmark information does not include the identity of any one of said plurality of clients.

22. The method of claim 18, wherein said benchmark information does not include the identity of any bidders participating in said plurality of bidding sessions.

23. An apparatus for conducting a bidding session, comprising:
means for establishing a communications channel with a web browser residing on a remote terminal;
means for transmitting bidding session status information to said web browser via said communications channel;
means for receiving a bid from said web browser via said communications channel; and
responsive to said means for receiving, means for transmitting an update of said bidding session status information to at least one web browser residing on at least one remote terminal, wherein said update has not been requested by said at least one web browser.

24. The apparatus of claim 23, wherein said bidding session status information comprises data representative of at least one of the following:
a bidding session sponsor,
a bidding session objective,
a bidding session format,
a bidding session date,
a bidding session timer,
a product being put to bid,
a product specification,
a required quantity,
a contract duration,
a contract delivery requirement,
a contract performance penalty,
a starting bid,
a last bid,
a bidding rank,
a bidding unit,
a minimum bid increment,
a start time for bidding,
an end time for bidding,
a new bid time extension value,
whether bid values are hidden,
a current bidding round number,
a number of total bidding rounds,
a number of bidders,
a bidder identification, and
a bidding history.

25. The apparatus of claim 23, further comprising means, responsive to said receiving means, for extending the duration of a bidding session a predetermined period of time.

26. The apparatus of claim 23, wherein said means for transmitting an update responds to said means for receiving a bid in real time.

27. The apparatus of claim 23, wherein said at least one web browser is the same as said web browser.

28. The apparatus of claim 23, further comprising means for qualifying bidders to participate in said bidding session.

29. The apparatus of claim 23, further comprising means for qualifying a subset of bidders to participate in at least one additional round of bidding.

30. The apparatus of claim 23, further comprising means for inviting bidders to participate in said bidding session.

31. The apparatus of claim 23, further comprising:
a bidding engine;
means for monitoring said bidding session; and
means for transmitting messages between said bidding session supervisor component and at least one web browser residing on at least one remote terminal.

32. The apparatus of claim 31, wherein said bidding session supervisor component and said remote terminal are located on opposite sides of a firewall.

33. The apparatus of claim 23, wherein said bidding status information comprises at least two kinds of products to be put to bid simultaneously.

34. An apparatus for conducting a bidding session, comprising:
a connection builder configured to establish a communications channel with a web browser residing on a remote terminal;
a first transmitter, wherein said first transmitter is configured to send bidding session status information to said web browser via said communications channel;
a receiver that receives a bid from said web browser via said communications channel; and
a second transmitter, responsive to said receiver, wherein said second transmitter is configured to send an update of said bidding session status information to at least one web browser residing on at least one remote terminal, wherein said update has not been requested by said at least one web browser.

35. The apparatus of claim 34, wherein said bidding session status information comprises data representative of at least one of the following:
a bidding session sponsor,
a bidding session objective,
a bidding session format,
a bidding session date,
a bidding session timer,
a product being put to bid,
a product specification,
a required quantity,
a contract duration,
a contract delivery requirement,
a contract performance penalty,
a starting bid,
a last bid,
a bidding rank,
a bidding unit,
a minimum bid increment,
a start time for bidding,
an end time for bidding,
a new bid time extension value,
whether bid values are hidden,
a current bidding round number,
a number of total bidding rounds,
a number of bidders,
a bidder identification, and
a bidding history.

36. The apparatus of claim 34, wherein, responsive to said receiver, the duration of said bidding session is extended a predetermined period of time.

37. The apparatus of claim 34, wherein said update is transmitted to said at least one web browser in real time.

38. The apparatus of claim 34, wherein said at least one web browser is the same as said web browser.

39. The apparatus of claim 34, wherein said second transmitter is the same as said first transmitter.

40. The apparatus of claim 34, further comprising a qualifier component, said qualifier component being configured to qualify bidders to participate in said bidding session.

41. The apparatus of claim 34, further comprising a qualifier component, said qualifier component being configured to qualify a subset of bidders to participate in at least one additional round of bidding.

42. The apparatus of claim 34, further comprising notification component, said notification component being configured to invite bidders to participate in said bidding session.

43. The apparatus of claim 34, further comprising:
a bidding engine;
a bidding session supervisor component configured to monitor said bidding session; and
a messaging system, said messaging system being configured to transmit messages between said bidding session supervisor component and at least one web browser residing on at least one remote terminal.

44. The apparatus of claim 43, wherein said bidding session supervisor component and said remote terminal are located on opposite sides of a firewall.

45. The apparatus of claim 34, wherein said bidding status information comprises at least two kinds of products to be put to bid simultaneously.

46. An apparatus for conducting a bidding session, comprising:
a connection builder configured to establish a communications channel with a web browser residing on a remote terminal located on the opposite side of a firewall;
a bidding engine;
a bidding session supervisor component configured to monitor said bidding session; and
a messaging system, wherein said messaging system transmits messages between said bidding session supervisor component and said remote terminal.
